(19) United States
(12) Patent Application Publication
(10) Pub. No.: US 2024/0367005 A1
(43) Pub. Date: Nov. 7, 2024

(54) ENHANCED ROBOTIC EXERCISE MACHINE AND METHODS THEREOF

(71) Applicant: Human-Robotix LLC, Arlington, MA (US)

(72) Inventor: Carmen FALCONE, Arlington, MA (US)

(21) Appl. No.: 18/655,699

(22) Filed: May 6, 2024

Related U.S. Application Data
(60) Provisional application No. 63/464,316, filed on May 5, 2023.

(51) Int. Cl. A63B 24/00; A63B 21/00; A63B 21/005; A63B 71/06; B25J 9/00; B25J 9/16

(52) U.S. Cl. CPC A63B 24/0075; A63B 21/0058; A63B 21/15; A63B 24/0062; A63B 71/0622; B25J 9/0087; B25J 9/1633; A63B 2024/0093; A63B 2220/51; A63B 2220/54; A63B 2220/805; A63B 2230/625

(57) ABSTRACT

An exercise machine includes computers, sensors, and at least one robotic arm, each robotic arm has a connector through which the robotic arm exerts force and torque on a user. Each robotic arm moves along a reference trajectory. The computer controls the robotic arm according to the corresponding reference trajectory. The sensors include force-torque sensors configured to measure the force and torque exerted on the user and vision sensors configured to measure the user's body posture. A method for controlling the exercise machine includes selecting an exercise motion, setting initial values for resistance force magnitude parameters and state variables, determining the user is ready to start exercising, obtaining measurements from the sensors, and based on the obtained measurements, updating the resistance force magnitude parameters and the state variables.

### RELATED APPLICATIONS

This application claims priority to U.S. Provisional Application No. 63/464,316 filed May 5, 2023, the disclosures of which are hereby incorporated by reference in their entirety.

### TECHNICAL FIELD

The present invention relates to a robotic exercise machine.

### BACKGROUND

Physical fitness is associated with more than just strong muscles and healthy lungs. The benefits of being physically fit include stronger bones, greater immunity, higher self-esteem, improved brain health, and an overall better quality of life. Strength training, or resistance training as it is sometimes called, is a key activity for physical fitness and physical therapy. Stretching and massage also support improved physical fitness, especially when done in conjunction with strength training.

Given the complexity of the human muscular system, effective and safe full-body strength training requires various kinds of equipment. Both compound and isolated muscle movements are essential in an effective exercise routine. This demands that an exercise machine possesses a certain degree of precision in tracking certain motions in three-dimensional space to recruit specific muscles. While equipment currently found at fitness centers and physical therapy centers has this capability, these machines lack many other features, limiting their safety and effectiveness. For example, control over how the resistance forces can change in three-dimensional space and over time is important, especially for users with injuries. Furthermore, if one machine is to be used for all muscle groups, then a high degree of adjustability and control of the machine-user interface is required to support various kinds of motions in three-dimensional space.

Some existing exercise machines might have disclosed such capabilities; however, they do not contemplate other critical issues related to safety, effectiveness, and versatility. For example, control over the orientation of the machine-user interface is not addressed. This is important because the interface of the user, such as their hands, can start out in different orientations for different exercise motions. Furthermore, for many exercises, the interface of the user naturally changes in orientation as the user performs the exercise motion. There is a need for an exercise machine that can automatically change the orientation of its machine-user interface, both to start an exercise and during the exercise motion.

The integration of warm-up and recuperative activities with strength training is vitally important. A user achieves synergies in performing these activities as part of their exercise routine. For example, dynamic stretching before and static stretching after strength training can reduce the risk of injury, mitigate muscle soreness, and restore lost mobility in muscles that may have shortened due to strength training. This allows the user to engage in more frequent strength training, and with reduced risk of interruption from injury. Many of the same exercise machine features for strength training apply to warm-up and recuperation with the same benefits of safety, effectiveness, and versatility. There is a need for an exercise machine that can support and facilitate warm-up and recuperative activities integrated with holistic exercise routines.

Fitness trainers, physical therapists, and other professionals bring their expert knowledge to bear, resulting in improved results for their clients. Their knowledge becomes embodied in an overall exercise plan, which comprises a series of personalized exercise routines, developed with an understanding of client goals and limitations. Their continued participation in their clients' routines is important. They coach their clients through the routine, provide corrective feedback and motivation, monitor and record progress, and evolve the exercise plan as necessary. Such continual trainer/therapist engagement can be expensive and is not always possible because of scheduling constraints. There is a need for an exercise machine that can automatically perform these same expert functions while a user carries out their routine.

Countless processes across numerous industries have been modernized with software applications and data-driven approaches. The process of creating exercise plans, however, has yet to fully benefit from this trend. A software application that works in conjunction with the exercise machine contemplated here would realize synergies by leveraging the data generated by the exercise machine during its use. There is a need for a software application, integrated with the exercise machine, that improves the efficiency of creating personalized exercise plans.

### SUMMARY

One aspect of this disclosure directs to an exercise machine, the exercise machine comprises at least one computer, at least one sensor, and at least one robotic arm. Each robotic arm has a connector through which the robotic arm exerts force and torque on a user. Each robotic arm moves along a reference trajectory. The computer controls the robotic arm according to the corresponding reference trajectory. The sensors include force-torque sensors configured to measure the force and torque exerted on the user and vision sensors configured to measure the user's body posture.

Another aspect of this disclosure directs to methods for controlling the exercise machine, comprising selecting an exercise motion, setting initial values for resistance force magnitude parameters and state variables, determining the user is ready to start exercising, obtaining measurements from the sensors, and based on the obtained measurements, updating the resistance force magnitude parameters and the state variables.

### BRIEF DESCRIPTION OF DRAWINGS

Various embodiments of the invention are disclosed in the following detailed description and the accompanying drawings. The drawings are not necessarily to scale; emphasis instead being placed upon illustrating embodiments of the present invention.

FIG. 1 illustrates a front view of one embodiment of an exercise machine.

FIG. 2 illustrates a plan view of the exercise machine of FIG. 1.

FIG. 3 is an illustration of an example of a GUI for creating new exercise plans.

FIG. 4 is a block diagram illustrating an embodiment of a hierarchical schema.

FIG. 5 is an illustration of an example of a GUI for editing exercise plan parameters.

FIG. 6 is an illustration of an example of a GUI for editing routine parameters.

FIG. 7 is an illustration of an example of a GUI for editing exercise parameters.

FIG. 8 is an illustration of an example of a GUI for editing set parameters.

FIG. 9 is an illustration of an example of a GUI for editing motion parameters.

FIG. 10 is an illustration of an example of a GUI used during exercise mode.

FIG. 11 illustrates a perspective view of one embodiment of a gripping connector.

FIG. 12 illustrates a perspective view of one embodiment of an attaching connector.

FIG. 13 is a diagram illustrating an example reference trajectory.

FIG. 14 is a diagram illustrating an example location along a reference trajectory and the different elemental forces that can act at this point.

FIG. 15 is a graph illustrating how speed can vary with resistance force.

FIG. 16 is a graph illustrating how radial force can vary with radial distance.

FIG. 17 is a flowchart illustrating an embodiment of a process for supervisory control of a robotic arm.

FIG. 18 is an image of an example of a GUI for creating new exercise motions through a method of user demonstration.

FIG. 19 is a flowchart illustrating a method of creating a new exercise motion by user demonstration.

FIG. 20 is a flowchart illustrating an embodiment of a process for converting raw exercise motion data into a usable reference trajectory format.

FIG. 21 is a flowchart illustrating an embodiment of a process for converting raw exercise motion data and vision sensor data into a reference trajectory tailored to a specific user.

FIG. 22 is diagram illustrating an example template for a kinematic body model of a user.

FIG. 23 is an illustration of an example of a GUI for a body scanning method.

FIGS. 24A-24F illustrate the exercise machine of FIG. 1 in use for various exercise motions including user position and path of motion (dotted lines), corresponding to several examples of different exercises among the infinite number of exercises possible with this exercise machine.

FIGS. 25A-25D show some alternative embodiments of the present invention.

### DETAILED DESCRIPTION

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents.

The present disclosure is generally directed to an exercise machine and methods that have application in strength training, physical therapy, and other related activities. It can also be applied in recuperative activities such as stretching and foam rolling. The robotic nature of the exercise machine provides versatility in the kinds of exercises and recuperative activities that a user can perform. More specifically, the versatility of the exercise machine derives from the degree of control over the position, orientation, velocity, and angular velocity of the machine-user interface. It also derives from the degree of control over the force and torque that the machine-user interface can exert on the user.

In some embodiments, the exercise machine may comprise at least one robotic arm, each of the at least one robotic arm has six degrees-of-freedom. In some embodiments, the exercise machine may comprise two robotic arms. Six degrees-of-freedom may enable almost any position and orientation within the workspace of a robot. Additional degrees-of-freedom can be useful in some embodiments, for example, in enabling a robotic arm to avoid a wrist singularity, thus expanding the set of possible motions within the workspace. In some embodiments, fewer degrees-of-freedom having lower cost and complexity can also be desirable, but at the expense of versatility.

In some embodiments, each robotic arm may physically interface with a user via its end effector. An end effector is a machine-user interface of the exercise machine referred to herein as a “connector”. In some embodiments, the robotic arm may exert force and torque on a user through a connector. In some embodiments, there may be different types of interchangeable and/or add-on connectors for interfacing with different parts of the user's body. For example, connectors may take the form of handles, pads, belts, rings, and devices designed to securely attach to different locations on the arms or legs of a user. In some embodiments, connectors may take the form of foam rollers, vibrating devices, and similar end effectors for recuperative or exercise purposes.

In some embodiments, the exercise machine may comprise at least one computer. In some embodiments, additional computers may be beneficial in the allocation of software execution, which may provide more reliable robotic arm control. In some embodiments, each robotic arm may be independently programed to automatically move its connector through almost any desired path of exercise motion. Each of the path of motion is represented by a reference trajectory, which may contain a time series of positions and orientations for the corresponding connector to follow. The terms “reference trajectory” and “trajectory” are used interchangeably herein.

In some embodiments, the exercise machine may comprise a non-transitory memory storing instructions and algorithms. In some embodiments, trajectories and software for controlling each arm may be stored in the memory. This may include supervisory control software which determines supervisory commands, such as connector velocity and angular velocity. It may also include low-level control software which determines motor voltages given input supervisory commands. The computer may execute the control software so that each connector responds to user-exerted forces as if it was physically constrained to move along its specified reference trajectory. This feature may make the exercise machine capable of duplicating the motion of virtually any mechanism.

While a specified trajectory is being enforced, the speed of the connector along this trajectory may be independently controlled according to the component of user-exerted force tangent to the trajectory at any given position. The functional relationship between the controlled connector speed and the component of user-exerted force tangent to the specified trajectory may take various forms. The relationship may also depend on other variables in addition to tangential force, such as time and location along the trajectory, among other quantities. Actively controlled speed and forces may not be limited to the direction tangential to the reference trajectory. In some embodiments, by allowing a connector to move within a volume around its reference trajectory, the robotic arm may exert force on the user through its connector in all three dimensions.

In some embodiments, the incorporation of graphical user interfaces (referred to herein as “GUIs”) may allow for user specification of how each connector generally behaves. In some embodiments, via a GUI, a user may specify parameter values that are used by the supervisory control software. For example, the user may specify which reference trajectories are to be used, how each connector behaves in response to forces, and how it follows the reference trajectory. For example, a user may specify parameters which define the functional relationship between user-applied tangential force and connector speed along the trajectory. As another example, a user may specify parameters which allow a connector to move in a direction normal to the reference trajectory in response to a user-applied normal force. In some embodiments, a user may specify forces to be exerted on a user that have a direction which is independent of the direction of the reference trajectory at any given position.

The term “trainer” and “physical therapist” can be used interchangeably herein and substituted for the term “user” in the context of creating exercise plans, routines, and motions.

Almost any imaginable form of exercise may be attained with the flexibility that results from software-based control combined with user specification of parameters. In some embodiments, the design of the GUI may enable a user to create an exercise by specifying the parameters that dictate the behavior of each connector. The GUI should embrace a schema by which the user can efficiently, and with sufficient detail, specify how the connectors behave throughout an exercise. In some embodiments, a user may use the same GUI to specify the entire exercise plan and its constituent routines.

In some embodiments, the exercise machine may comprise a video display (referred to herein as a “display”) for user interaction. In some embodiments, additional displays may be beneficial for improving user viewability and user access. In some embodiments, the display may present GUIs, which facilitate information exchange between user and exercise machine. In some embodiments, the mode of the exercise machine may determine the kinds of GUIs that are presented on the display. At any given time, the exercise machine may operate in one of a plurality of possible modes. In this specification, for the purpose of understanding, the modes are referred to herein with the following terms: “Idle”, “Exercise”, “Training”, “Teaching”, and “Body Scanning”.

In Idle Mode, the exercise machine may wait for a user to log in. In Exercise Mode the user may be engaged in resistance training as part of a scheduled exercise routine. In Training Mode, the user may be engaged in assistive motions, such as being guided through a new exercise motion by the exercise machine. Training Mode may also include recuperative activities, such as assisted stretching. In Teaching Mode, the user may demonstrate an exercise motion that is simultaneously recorded and subsequently processed by the exercise machine. The processed motion data may be saved and can be used as part of future exercise routines. In Body Scanning Mode, the exercise machine may develop a personalized kinematic model of the user's body.

In some embodiments, the exercise machine may comprise various sensors for monitoring the user, the exercise machine itself, and their interaction. Vision sensors may provide input to human pose estimation (referred to herein as “HPE”) processing. HPE may enable numerous features. For example, HPE is instrumental in Body Scanning mode, during which the user's body is scanned to automatically develop a kinematic model specific to the user's body. In some embodiments, in Teaching Mode, HPE may determine user joint angles as they were throughout the demonstration of an exercise motion. The kinematic body model (referred to herein as “KBM”), with these user joint angles applied, may allow for adaptation of exercise motions to any user. In some embodiments, HPE may also be used during Exercise Mode. First, this information may help the user with initial positioning and pose of their body when starting an exercise. Second, HPE information may enable real-time feedback to the user regarding their form while performing an exercise. In some embodiments, HPE information can be stored and used afterwards for post-routine data analysis.

In some embodiments, the exercise machine may comprise cloud resources which are remote but connected to the exercise machine via the internet. The terms “cloud resources” and “cloud” are used interchangeably herein and refer to remote computer resources that are accessed via the internet. In some embodiments, the cloud may provide data storage and computation resources. In some embodiments, the cloud can download data to the exercise machine. In some embodiments, the exercise machine can also upload data to the cloud. For example, data collected by sensors can be uploaded to the cloud. This connectivity enables multiple capabilities. For example, data can be analyzed in the cloud across all users and exercise machines. As another example, every instance of every exercise machine is accessible to all users with their own saved exercise routines and personalized motions.

In some embodiments, the cloud may also deliver to a user's devices browser-based web applications (referred to herein as “web apps”) providing various capabilities. These capabilities can include, for example, supporting management of a user's online account, scheduling of exercise routines, visualizing historical exercise performance data, and comparing that data over time and/or across different users. In some embodiments, a critical capability is providing a GUI that enables user creation of exercise plans, routines, and exercises which from the cloud can be downloaded to and used by the exercise machine. In some embodiments, this GUI may embrace a hierarchical schema that drives user efficiency in the creation process. In some embodiments, the web app may publish these creations for broad user access, and/or sharing them with specific users.

In some embodiments, a mobile application (referred to herein as a “mobile app”) may connect to the cloud. In some embodiments, the mobile app may have some of the same capabilities as the web apps, but also provide unique capabilities such as location-based features and real-time notifications. In some embodiments, the mobile app may facilitate user log in to the exercise machine.

This disclosure can be implemented in numerous ways, including as: a process; an apparatus; a system; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

The exercise machine may comprise proprietary, purpose-built robotic arms. However, there are several different types of commercially available robotic arms, and many different models of each type are available. General-purpose robotic arms that are designed for human interaction are referred to as “cobots”. A cobot is usually available as a package including the cobot arm, a computer for controlling the arm, and other components. A cobot arm may comprise all the electronics, motors, gearing, and sensors required to precisely control it. Most cobots may comprise a force-torque sensor at the end of the arm for sensing three-dimensional forces and torques that are exerted on the end effector.

Two distinctive aspects of a cobot computer are the inclusion of software for low-level control of the arm and a port for communicating with the cobot arm. The cobot computer executes the software program for low-level control. This executing process is referred to herein as the “low-level controller”. Supervisory commands in the form of three-dimensional position and orientation can be transmitted to the low-level controller. The low-level controller determines the series of voltages to be applied to the motors, thus moving the end effector to that commanded position and orientation. Supervisory commands can also be in the form of three-dimensional velocity and angular velocity. In this case the low-level controller determines how the voltages need to vary over time so that the end effector moves at the commanded velocity and angular velocity.

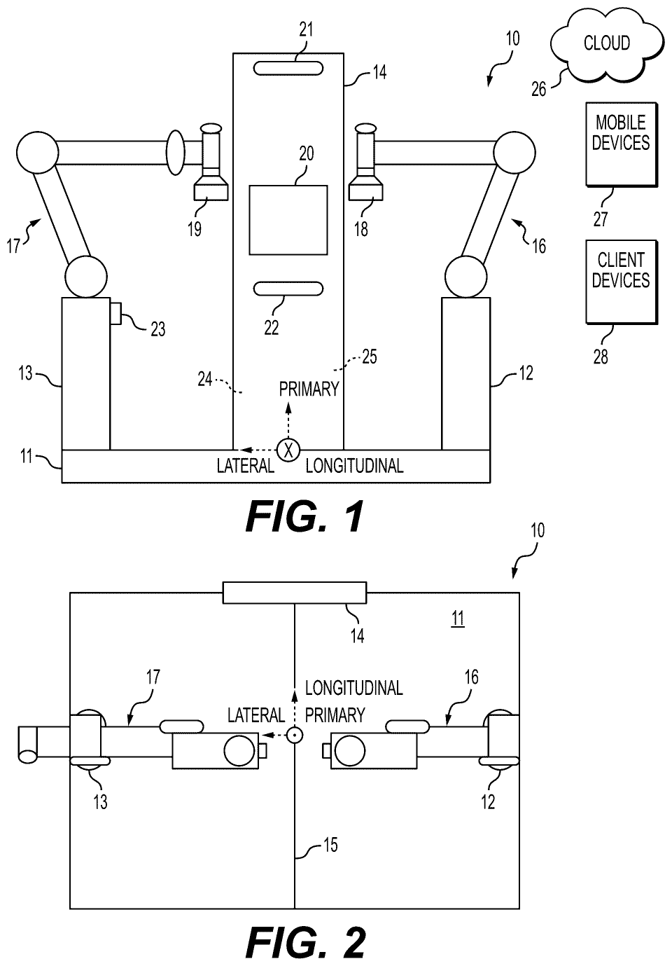

With reference to FIGS. 1 and 2 showing an embodiment of the exercise machine (10), the exercise machine (10) comprises a platform (11) to which two pedestals (12, 13) and a user console (14) are attached. A centerline (15) marking is visible on the platform (11) in FIG. 2. The centerline (15) bisects the distance between the pedestals (12, 13), visually dividing the platform (11) into two areas. In some embodiments, the purpose of the centerline (15) is to provide a frame of reference for the user; it is not a strictly necessary element. In some embodiments, a first robotic arm (16), which is a cobot arm, may attach to a first pedestal (12). In some embodiments, a second robotic arm (17), which is a cobot arm, may attach to a second pedestal (13) on the opposite side of the centerline (15). In some embodiments, the pedestals (12, 13) may raise the robotic arms (16, 17) to a height suitable for use by a user. In some embodiments, the distance between the pedestals (12, 13) may put the robotic arms (16, 17) at a lateral distance suitable for use by a user. In some embodiments, the user console (14) may be positioned on the centerline (15) at a suitable distance from the pedestals (12, 13) so that it does not interfere with exercise motions, but close enough for convenient user interaction. This arrangement of robotic arms (16, 17), user console (14), and centerline (15) is shown in the plan view of FIG. 2.

In some embodiments, a first connector (18) may attach to the first robotic arm (16), and a second connector (19) may attach to the second robotic arm (17). In some embodiments, the user console (14) may comprise a touchscreen display (20) for user interaction and vision sensors (21, 22) for monitoring the user. In some embodiments, a first vision sensor (21) may be located relatively high on the user console (14) to obtain a downward looking perspective on the user. In some embodiments, a second vision sensor (22) may be located lower on the user console (14) to obtain a different perspective. In some embodiments, a third vision sensor (23) may be located on the pedestal (13) to obtain yet another perspective. In some embodiments, the vision sensors (21, 22, 23) may be fixed in location and orientation.

In some embodiments, two computers (24, 25) may be located inside of the user console (14). In some embodiments, each of the computers (24, 25) may include at least one general purpose processing device or “processor”, dynamic random access memory, static memory, a network interface device, and other components that communicate with each other via a bus. In some embodiments, the two computers (24, 25) may share the effort of executing software programs which operate the robotic arms (16, 17), the display (20), the vision sensors (21, 22, 23), and the GUIs. In some embodiments, one or both computers (24, 25) may communicate with remote resources. For example, one or both computers (24, 25) can communicate over the internet with remote resources in the cloud (26). As another example, one or both computers (24, 25) can communicate with a user's mobile device (27), such as a phone, tablet, or similar device with short-range wireless communication capability. Furthermore, cloud resources (26) may communicate with client devices (28). “Client devices” (28) refers to devices that can run an internet browser or web-based application, and to which the cloud (26) delivers web apps.

FIG. 2 shows a three-axis cartesian coordinate frame (referred to herein as the “base coordinate frame”) located at the center of the platform (11). The component axes of the base coordinate frame (“primary”, “lateral”, and “longitudinal”) are individually referred to herein. The primary axis points upward, perpendicular to the platform (11). The lateral axis is parallel to and immediately above the platform (11). It points in a direction parallel to an imaginary line connecting the two pedestals (12, 13). The longitudinal axis is perpendicular to the plane defined by the other two axes, is located immediately above the platform (11), and points toward the user console (14).

### Creating New Exercise Plans

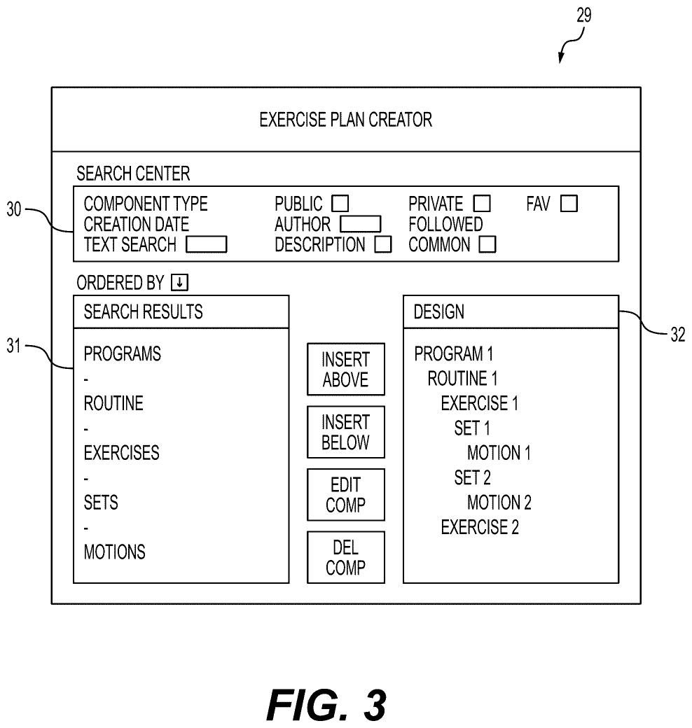

In some embodiments, a browser-based web app may be delivered to a client device (28) by cloud resources (26). In some embodiments, the web app may provide various features via different GUIs. In some embodiments, a user may have the ability to create and manage exercise plans. An example GUI (29) providing such capability is shown in FIG. 3. In some embodiments, the Exercise Plan Creator GUI (29) may embrace the natural hierarchical containership relationships intrinsic to the conceptual structure of exercise. This may enhance user efficiency in creating and managing exercise plans. In some embodiments, the GUI (29) may achieve this with graphical objects that reflect the conceptual components of an exercise plan. In some embodiments, the GUI (29) may allow the user to manipulate these graphical objects and graphically organize them in a hierarchical structure according to an established schema. As used herein, a “user” may refer generally to an individual operator of one or more exercise machines (10) and/or client devices (28).

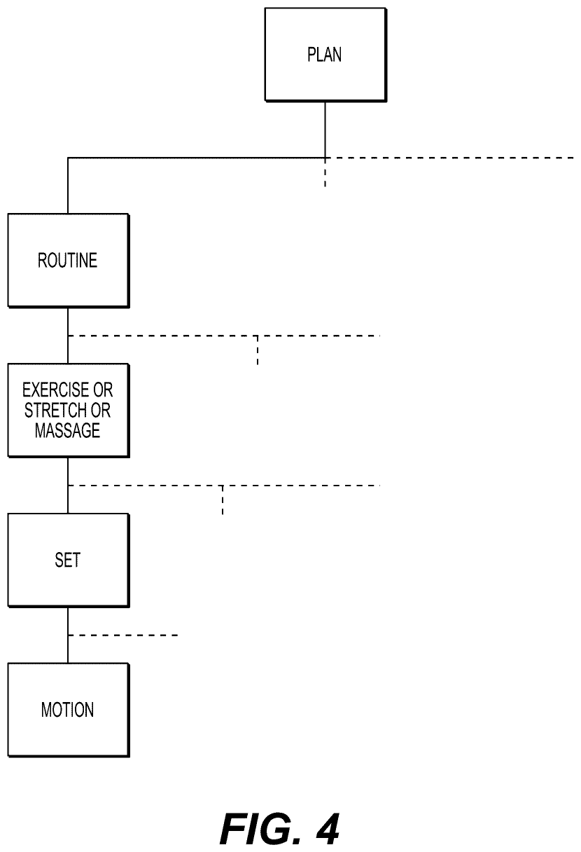

Various hierarchical schemas can be used. An exemplary embodiment of one schema is shown in FIG. 4. Note that the terminology used for the different levels of the hierarchy borrows from the lexicon of fitness trainers. Any schema that is adopted should result in instances of hierarchies that represent a temporal decomposition. In general, in any instance of a hierarchy that follows the schema, the time scale of any object should be equal to the sum of the time scales of the objects linked directly below it in the hierarchy.

A user may follow a particular exercise plan over extended periods of time, perhaps over many months. Therefore, the object at the highest level of the hierarchy is referred to herein as the exercise “Plan”. An exercise routine is what the user follows during a session, for example, in a visit to a fitness center. Therefore, what a Plan consists of are referred to herein as “Routines”. A Plan may have one or more Routines. A user may repeatedly cycle through the routines of their exercise plan. During a routine a user may perform various exercises. For each exercise the user usually repeats several sets. Each set may be associated with a continuous user activity. Therefore, each Routine may consist of one or more “Exercises”, and each Exercise may consist of one or more “Sets”. The Sets of an Exercise may or may not be similar. “Super-setting” may involve the user repeatedly cycling through two different kinds of sets. Finally, each Set may consist of one or more “Motions”. For recuperative activities, Exercise may be replaced by “Stretch” or “Massage”.

In some embodiments, in performing a set, a user may repeat a motion a specified number of times. Each repetition is referred to herein as a “rep”. In some embodiments, motions may be at the lowest level of the hierarchy, and typically, a set is associated with only one motion. In some embodiments, different motions may be combined in a set, such as cycling between a forward lunge and reverse lunge. In this case, two different Motions may be specified for the Set, and the user while performing the set may cycle through the two different motions as part of each rep. In some embodiments, for each connector, the starting positions and orientations across the Motions of a Set are identical.

The capitalized terms “Plan”, “Routine”, “Exercise”, “Stretch”, “Massage”, “Set”, and “Motion” refer to the graphical objects that a user can manipulate in a GUI, such as the Exercise Plan Creator GUI (29). Note that each instance of these graphical objects presented by a GUI may be associated with a particular set of stored data values that define the object. Therefore, the capitalized terms can also refer to the underlying stored data values. Each object organized hierarchically beneath a Plan, including the Plan, is generally referred to herein as a “Component”.

In some embodiments, each type of Component may have certain parameters and data values that define it. For example, a Motion may have a reference trajectory for each connector involved in the exercise. The time series data of a reference trajectory may specify the positions and orientations that a connector is to assume throughout an exercise motion. As another example, a Set may have a parameter for the number of reps. The value assigned to this parameter may specify the number of times a user is to traverse a reference trajectory, first with a forward stroke and then with a return stroke, while performing a set. Note that a forward stroke is referred to as a “positive” stroke and a return stroke is referred to as a “negative stroke”. As another example, an Exercise may have a parameter for the number of sets. The value assigned to this parameter may specify the number of times a user cycles through the sets of the exercise, resting after each cycle.

In some embodiments, for any given Component to be fully specified, all its parameters are to be specified with values, and all the required Components organized below it in the hierarchy are to be fully specified. In this schema, each Component may require one or more Components linked below it in the hierarchy, except for Motions, which have no Components linked below. In some embodiments, the exercise machine (10) may download and use routines that are fully specified.

In some embodiments, from the Exercise Plan Creator GUI (29), a user may create any type of Component “from scratch”. Additionally or alternatively, a user may re-use previously created Components by optionally modifying and/or saving them under a different name. In some embodiments, reusing existing Components may improve user efficiency in the creation of a new Plan or other Components. In some embodiments, a “Search Criteria” pane (30) may enable a user to sift through and home in on relevant Components of interest. Search criteria may include, for example, the primary muscles involved in an exercise, and whether the Component exists in the personal library of the user and/or in a public repository of Components. Search results may appear in the “Search Results” pane (31). In some embodiments, the user may order results according to user-selected criteria, such as creation date or popularity. In some embodiments, the user may use the search results to create new exercise Plans or other Components. For example, the user can “drag-and-drop” Components from the Search Results pane (31) over to the Design pane (32) and link them into a hierarchical structure according to the rules of the schema. In some embodiments, the web app may automatically enforce these rules. In some embodiments, the Design pane (32) may hold the Components that are currently being assembled into an instance of a new Plan or other kind of Component.

In some embodiments, the search and re-use of Components, and their hierarchical organization in a GUI that supports a visual design process with drag-and-drop may all be drivers in enhancing efficiency in the creation and management of exercise Plans and other Components. In some embodiments, Component sharing between and among users may also be an efficiency driver. In some embodiments, a user may share Components from one account to accounts of one or more other users. In some embodiments, a user may publish a Component broadly, sharing it with a public repository making it available to a community of users or all users. In addition to search capability, in some embodiments, a recommendation system can suggest Components. In some embodiments, suggestions may be based on numerous factors such as what has already been included in a new Routine and the effectiveness of the Exercises based on historical data across users.

### Editing Exercise Parameters

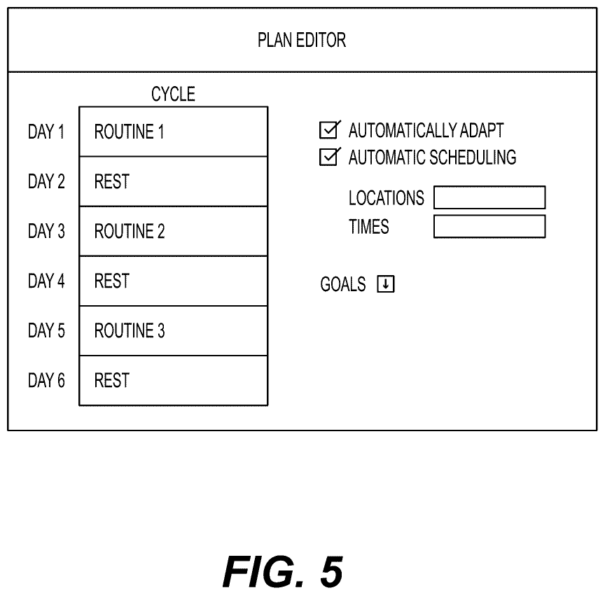

In some embodiments, from the Exercise Plan Creator GUI (29), a user may edit the parameters of a Component by, for example, double-clicking a specific Component in the Design pane (32). In some embodiments, based on the type of Component selected, the user may access the appropriate type of edit window or pane. In some embodiments, with each Component type having different kinds of parameters that define it, each type may have its own specific editing window or pane. FIG. 5 shows an exemplary GUI for editing the parameters of a Plan. In this exemplary embodiment, a user may specify parameters related to the goals of the user, such as increase in strength, endurance, and/or mobility for specified parts of their body. In this exemplary embodiment, parameters of the Plan include an on/off toggle for automatic adjustment of resistance levels based on user performance. In this exemplary embodiment, another toggle may enable automatic scheduling of routines with associated parameters specifying desired locations, times, and number of rest days.

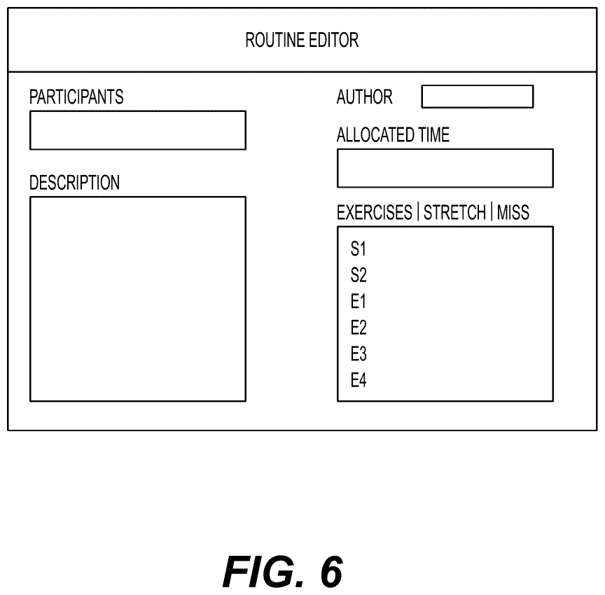

FIG. 6 shows an exemplary GUI for editing a Routine. In this exemplary embodiment, the user may specify, among other parameters, the default participants, an author of the Routine, and total routine duration, which is the amount of time that will be reserved as part of scheduling the routine.

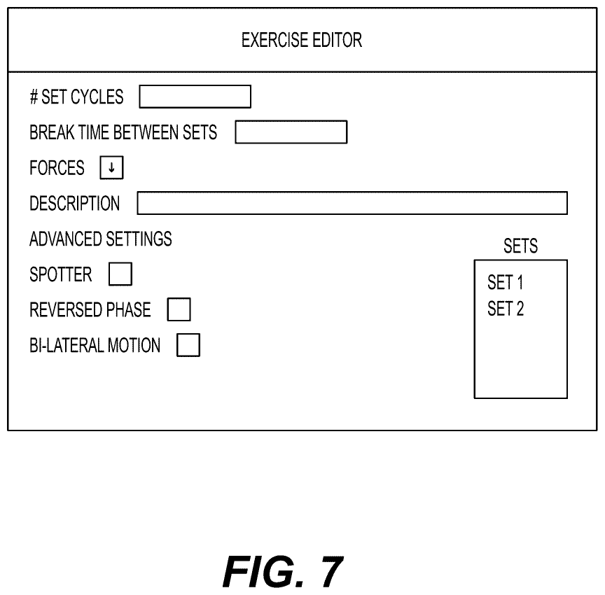

FIG. 7 shows an exemplary GUI for editing an Exercise. In this exemplary embodiment, the user may specify, among other parameters, the number of times the sets of the exercise are to be cycled through by the user, the rest time between sets, the type of resistance force and the associated resistance force parameters, and a description for the exercise. In this exemplary embodiment, another option is a toggle for a “spotter” feature. If enabled, movement of the connector during the forward stroke is not permitted in the direction of the return stroke. In this exemplary embodiment, other advanced options include a toggle for “reversed-phase”, in which two connectors are perfectly out of phase; “reversed-phase”, in which one connector is in the forward stroke while the other connector is in the return stroke; “bilateral motion”, in which two connectors move in unison along their respective reference trajectories and their tangential movement along each trajectory is based on the sum of force across both connectors.

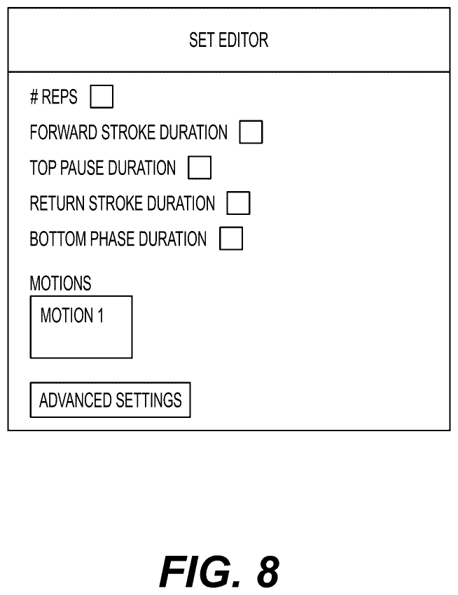

FIG. 8 shows an exemplary GUI for editing a Set. In this exemplary embodiment, the parameters include, among others, the number of reps, and the expected durations for different parts of the motion. In this exemplary embodiment, these durations include the amount of time for the forward stroke, the return stroke, and the amount of time the user is to pause at the top and bottom of the motion. In this exemplary embodiment, there are also advanced settings, such as parameters for the size of different zones around the reference trajectory and for changes to the resistance force after each rep.

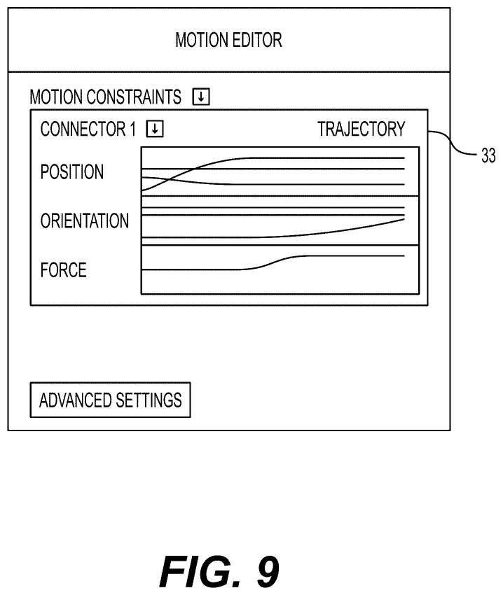

FIG. 9 shows an exemplary GUI for editing a Motion. In some embodiments, in Exercise Mode, a user may have the option of disabling any zero-motion constraints that were imposed during Teaching Mode. In some embodiments, user may specify parameters for those constraints in this GUI. In some embodiments, the user may specify scaling of the resistance force as a function of the distance of the connector along the reference trajectory. In some embodiments, this may be achieved through a force scaling multiplier that is specified at each point of a reference trajectory. Because it is a time series, a user may efficiently edit the force scaling multiplier via graphical manipulation. In some embodiments, the Trajectory pane (33) may present a graph of the time series of the position and orientation for each connector, and the time series of the force scaling multiplier. In some embodiments, the user may edit the force scaling curve, for example, by dragging a point on the curve or by selecting points to adjust with buttons that change the value of the scaling multiplier up or down. In some embodiments, the GUI may allow similar manipulation of position and orientation time series values.

In some embodiments, a Motion may contain a reference trajectory for each connector involved in the exercise. In some embodiments, trajectory data may be indexed by duration. In some embodiments, duration may be measured as the passage of time relative to when the connector begins to move along the trajectory. In some embodiments, the duration values can undergo adjustment via user specification. For example, if total duration of the forward stroke is explicitly specified in a Set, then the values of duration for the Motion associated with said Set may be automatically scaled by a constant factor such that the value of the final duration index matches the user specification for forward stroke duration. In some embodiments, advanced settings may include a toggle for the “circular trajectory” feature. With this option the end of a trajectory may connect back to its beginning, so there is no return stroke, just forward strokes with reps counted every time the connector returns to the beginning of the trajectory.

### Other Web Application Features

In some embodiments, other functionalities that are available in a web app and/or mobile app may include the ability for a user to create and maintain an online account and ability to search for other users. In some embodiments, a user may invite another user to join their social network or “follow” another user. In some embodiments, when logged in to their account, a user may view their historical progress at different levels of abstraction. In some embodiments, at a low level of abstraction, a user may review previously completed routines and their performance in those routines. In some embodiments, at a high level of abstraction, a user may view data associated with their strength-endurance-mobility profile, and how that has changed over time. A strength-endurance-mobility profile is referred to herein as a “SEM profile”. In some embodiments, the processor may automatically maintain an SEM profile on the cloud (26) as the user progresses through routines and the processor captures information from the exercise machine (10) about their performance. In some embodiments, a user's SEM profile may enable automatic adaptations that can occur over the course of an exercise plan and automatic adaptation of one user's Routine to another user, thus facilitating partner-based exercise.

In some embodiments, other features that are available in a web app and/or mobile app may include functionality for scheduling routines. In some embodiments, related features may include the ability to invite other users to a scheduled routine. In some embodiments, a user may direct an invitation to one other user, or to multiple users, based on certain criteria, and the user that accepts first may join the scheduled routine. Similarly, in some embodiments, a user may set a scheduled routine to be “open” for another user to find, review, and optionally join. In some embodiments, the inviting user may define the subset of community members who have access to seeing that routine as open with certain user criteria, such as limiting it to those users to whom the inviting user is connected. In some embodiments, these same features may also be available on a mobile app with location-based features leveraged. For example, the processor may send a notification via the cloud (26) or mobile app to the mobile phone of a user if they are in close proximity to an exercise machine (10) that has an available time.

In some embodiments, when additional users are added to another user's scheduled routine, the Routine parameters may adapt to the added users based on their respective SEM profiles. In some embodiments, the Routine parameters for the original user may not be affected; the changes made for the added users may apply only when they are each the active user performing a set with the exercise machine (10). This feature is useful for a “group class” organized by, for example, a fitness trainer.

In some embodiments, a web app may support third-party accesses. For example, an administrator may want to schedule a routine for a user on behalf of a physical therapist. Another example is insurance company access for visibility into physical therapy progress of a user.

### Exercise Mode

In some embodiments, a user may schedule Routines, for the user themselves or a different user, on a specific date, time, and exercise machine (10). In some embodiments, two or more machines (10) that are near each other can be reserved for scheduled routines involving two or more users. In some embodiments, the processor may download the Routine from the cloud (26) to a specified machine (10) in advance of the scheduled time. In some embodiments, at the scheduled time, the user may log in to the designated exercise machine (10), which may automatically transition from Idle to Exercise Mode. In some embodiments, a user may perform login by one of various methods. For example, in lieu of traditional user name and password, the user's mobile app can present a QR code to be scanned by the exercise machine. For another example, the exercise machine (10) may include a fingerprint reader so the users may log in with their fingerprints.

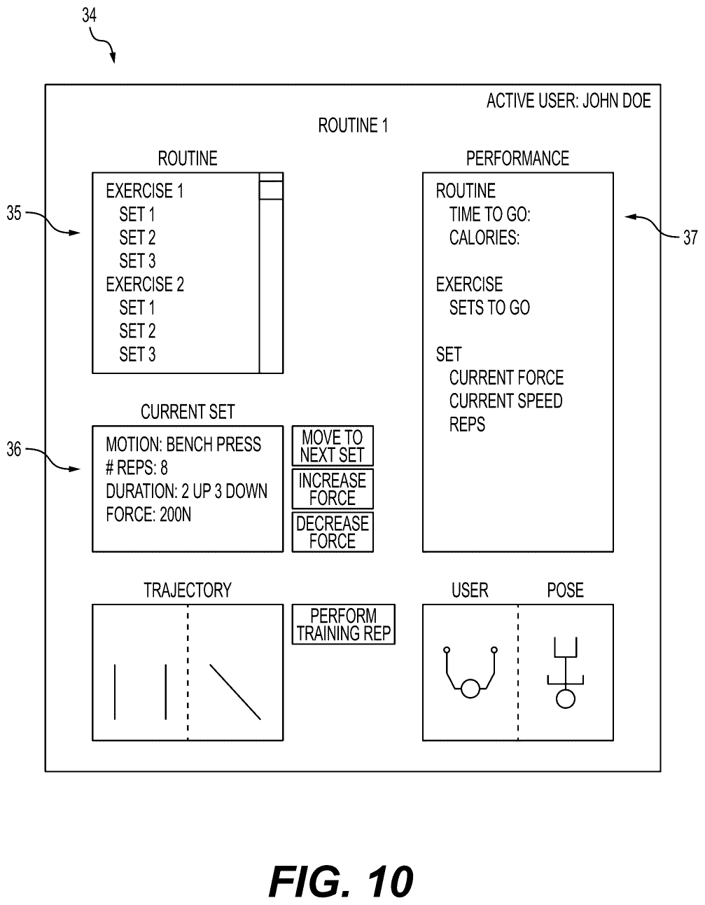

In some embodiments, the machine (10) may support the user in various ways throughout the routine. In some embodiments, prior to each set, the robotic arms may automatically move their respective connectors into the starting position and orientation as specified in each Set of the Routine. In some embodiments, an Exercise Mode GUI may support the user throughout the routine. An exemplary Exercise Mode GUI (34) that the user can view on a display, such as display (20), during Exercise Mode is shown in FIG. 10. In some embodiments, one of the computers (24, 25) may execute the software program for GUI (34).

In some embodiments, many Exercise Mode GUI layouts may be possible and various types of information may be presented during Exercise Mode. Furthermore, different users desire different information. In some embodiments, a web app may allow a user to depart from the default GUI and customize the content, format, and layout of information that is presented during Exercise Mode. In some embodiments, these preferences may be stored in the cloud (26).

In some embodiments, the Routine pane (35) of the example Exercise Mode GUI (34) may present the current Routine hierarchy. This is helpful in providing context to the user regarding where they are in their current routine. This is an “expanded” view of the hierarchy. For example, consider an Exercise that has only one Set associated with it in the Design pane (32), but the Exercise parameter for the number of sets has a value of three. That same Exercise in the Routine pane (35) will have three Sets appear beneath it. If the Exercise is a super-set exercise with two different kinds of sets, then the number of Sets in the Routine pane (35) would be expanded to six. Note that in this exemplary embodiment, the expanded view of a Routine in the pane (35) only presents the “Exercise” and “Set” levels. This portion of the Routine may strictly represent a temporal decomposition. More specifically, the duration of the Routine may be equal to the sum of durations of all the constituent Exercises; and the duration of each Exercise may be equal to the sum of durations of its constituent Sets.

In some embodiments, the Current Set pane (36) may present details of the currently active Set, including the name of the motion, the number of reps, the duration of a rep, and a resistance force value. In some embodiments, next to that information may be buttons that allow the user to adjust certain parameters in real-time. In some embodiments, at the top-right of the GUI (34) may be the name of the active user that is designated for the current set. This may be especially relevant for partner- or group-based routines.

In some embodiments, the Performance pane (37) may depict the performance of the active user and their progress in the routine. In some embodiments, as with the Exercise Plan Creator GUI (29), it is beneficial to leverage the hierarchical structure of a Routine in portraying user performance and progress. This may facilitate user consumption of such information. In some embodiments, at the top of the Performance pane (37) may be high-level information about the routine, such as total time-to-go and total calories burned. In some embodiments, in the middle of the Performance pane (37) may be information about the number of sets completed and below that is the number of reps completed. In some embodiments, at the bottom of the pane (37) may be instantaneous information such as actual force applied. In some embodiments, at the bottom of the Exercise Mode GUI (34) may be a visualization of connector positions along their reference trajectories. In some embodiments, there may be another visualization at the bottom including real-time HPE information. In some embodiments, this may be presented as a graphical representation of the user's KBM with body position and joint angles applied. In some embodiments, the processor may estimate the body position and joint angles using the real-time HPE process. In some embodiments, the processor may overlay a second KBM on this visualization with proper body position and pose applied. In some embodiments, this visual feedback may help the user in getting into proper position and pose to start the set, and may subsequently help the user maintain form throughout the set.

In some embodiments, information, such as feedback regarding user form, may be relevant to the user while performing a set. In some embodiments, the exercise machine (10) may include an additional display because the one display (20) may not be easily viewable for some exercise motions. In some embodiments, to maximize viewability, the additional display may be on a movable mounting arm or take the form of augmented reality glasses. In some embodiments, an additional display may be the user's own mobile device (27), which may establish a connection to one of the two computers (24, 25). In some embodiments, the mobile device (27) may be mounted in different locations on the exercise machine (10). In some embodiments, the mobile device (27) may execute a mobile app that controls what appears on its display.

In some embodiments, the Exercise Mode GUI (34) may include many other features, such as presenting a graphical animation of the motion to be performed in the upcoming set. In some embodiments, the GUI (34) may allow the user to temporarily transition the exercise machine (10) from Exercise Mode to Training Mode. In some embodiments, in Training Mode, the connectors may actively guide the user through an exercise motion prior to the user performing the motion with resistance applied. In some embodiments, the exercise machine (10) may require a trigger to initiate active movement of connectors. In some embodiments, the user may specify the triggers and include, for example, the user simultaneously nudging each connector involved in the motion. In some embodiments, the user may specify other types of triggers. For example, a trigger may be based on a time delay or input to the machine (10) from an exercise partner.

### Robotic Arms and Connectors

In some embodiments, the robotic arms of the exercise machine may each have at least five actively controlled joints. With fewer than five active joints, the orientations and motions that can occur within the workspace may be overly diminished, limiting the variety of exercises that can be performed. In an exemplary embodiment with five actively controlled joints per robotic arm, each connector may require at least one passive degree-of-freedom. This may enable the connector to assume an adequate variety of orientations within the workspace of the robotic arm, but with some degradation in the overall user experience. Another exemplary embodiment with seven actively controlled joints per robotic arm may mitigate the problem of wrist singularities, enabling the connectors to achieve a wide variety of motions within the workspace. The additional actively controlled joints, however, may introduce additional complexity and cost.

In some embodiments, the robotic arms (16, 17) may each comprise six actively controlled joints. This may enable precise control over almost any position and orientation within the workspace. In some embodiments, the existence of a wrist singularity may exclude certain relevant motions from being possible. Therefore, in some embodiments, it is beneficial for the connector to have one passively rotating joint. In some embodiments, the passive joint axis may not be parallel with the rotational axis of the final actively controlled joint of the robotic arm to which the connector is attached. This additional rotational axis may help with avoiding wrist singularities thus expanding the set of possible trajectories. In some embodiments, a gripping connector, which is designed to be gripped by the hand of a user, may be an example of a connector for which a passive degree-of-freedom is beneficial. Any passive rotational joints of a gripping connector may have a feature whereby each joint can optionally and independently lock.

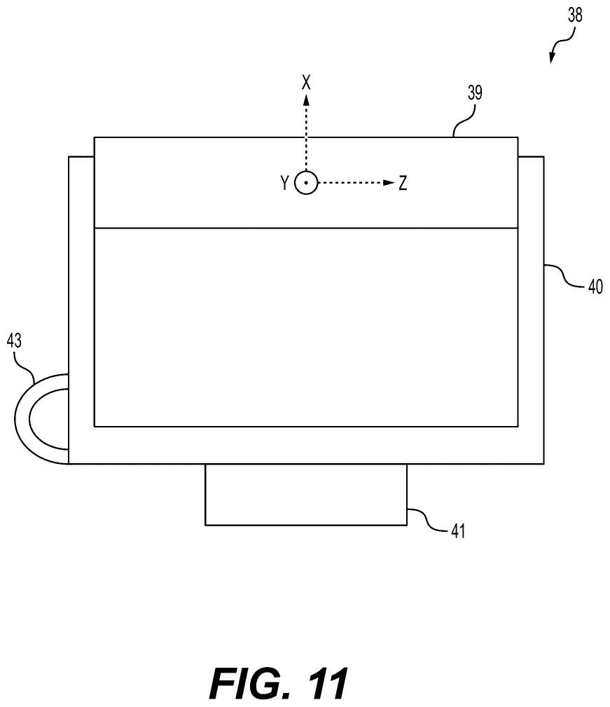

FIG. 11 shows an exemplary embodiment of a gripping connector (38) and its X-Y-Z body coordinate frame, which is centered in the handle (39). In some embodiments, the handle (39) may be designed to be gripped by the hand of a user. In some embodiments, the handle (39) may optionally rotate about the Z-axis relative to the frame member (40) to which it is attached. In some embodiments, frame member (40) may also optionally rotate about the X-axis relative to the member (41) to which it is attached. In some embodiments, the member (41) may attach to the end of a robotic arm (16, 17) of the exercise machine (10). In some embodiments, the body coordinate frame may move with the gripping connector (38) from movement arising from the active control of the robotic arm to which the gripping connector (38) is attached. Therefore, in some embodiments, the body coordinate frame for the gripping connector (38) may be conceptually “attached” to it. However, the body coordinate frame does not move because of rotation of any unlocked passive joints of the gripping connector (38).

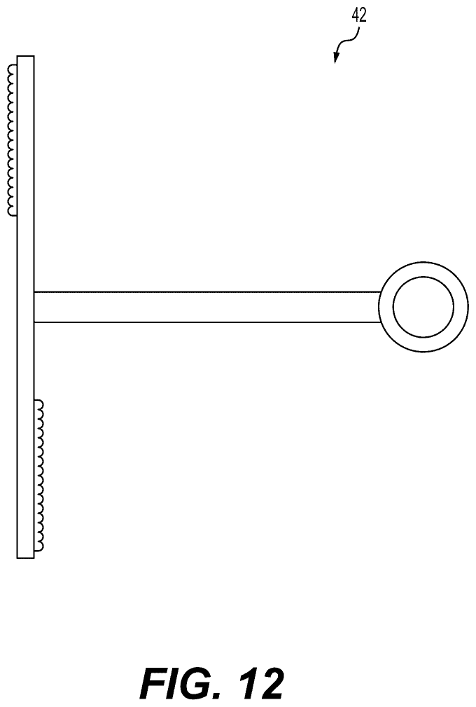

FIG. 12 shows an exemplary embodiment of an attaching connector (42). In some embodiments, it may be a flexible strap that at one end it may attach to a part of the user's body, such as their ankle, via a flexible brace with a fastener, and at the other end of it may be a loop that may attach to, for example, the loop (43) of the gripping connector (38) via a carabiner. In some embodiments, this attaching connector (42) may be deemed a type of add-on connector because it must attach to a different connector that is attached to a robotic arm (16, 17). Because of its flexible nature, in some embodiments, the attaching connector (42) may only support a tensile force that is directed along the length of the strap. Therefore, while a user is performing a set using the attaching connector (42), the robotic arm (16, 17) that is attached to the connector (42) via the gripping connector (38) may continually attempt to position the gripping connector (38) appropriately. More specifically, the position of the gripping connector (38) may continually be adjusted throughout the motion such that the direction of the strap is parallel to the velocity of the location on the user's body to which the connector (42) is attached.

### Reference Trajectory

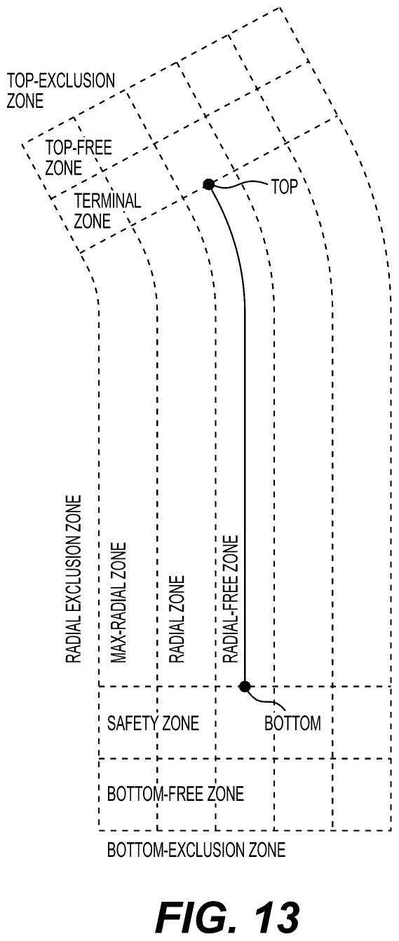

In some embodiments, each robotic arm (16, 17) may enable its connector, such as the connectors (18, 19) of FIG. 1, to follow a user-specified reference trajectory and exert forces and/or torques of specified magnitude and direction back on the user. FIG. 13 shows the positional components of an exemplary reference trajectory, along with different points and zones that may exist on and around the trajectory. For the purpose of clarity, FIG. 13 shows a simple, nearly straight-line trajectory. The “bottom” (i.e., starting point) of the exemplary trajectory is where the forward stroke of the exercise motion normally begins. The location of the bottom, by default, is the first point in the time series of trajectory position data, or the starting point. The “top” of the exemplary trajectory is where the forward stroke normally ends (i.e., ending point of the forward stroke), and the return stroke begins (i.e., the starting point of the end stroke). The location of the top, by default, is the final point in the time series of trajectory position data. In some embodiments, user specifications may modify where on the trajectory the bottom and top are located. These two points may also be specified to exist on a line extrapolated from the first or final point of the trajectory. In some embodiments, the completion of a rep may be defined by a forward stroke, which entails the user moving the connector from the bottom to the top, followed by a return stroke, which entails the user moving the connector from the top back to the bottom.

In some embodiments, the “safety zone” may be the area below the bottom of the reference trajectory. In some embodiments, the safety zone may be perpendicular to the trajectory at the bottom of the trajectory and its size may be specified by a height parameter. In some embodiments, the default behavior in the safety zone may be for the magnitude of any forces actively exerted on the user to gradually transition to zero as the connector moves from the bottom of the trajectory through to the other side of the safety zone. In some embodiments, both user safety and robot wear considerations may be the motivation for this functionality. Therefore, in some embodiments, if the connector is not moving or moving very slowly inside of the safety zone, the active forces exerted on the user may immediately diminish to zero.

In some embodiments, the “bottom-free zone” may exist below the safety zone and its size may be specified by a height parameter. In some embodiments, the “bottom-free zone” may be perpendicular to the trajectory at the bottom. In this region the connector may exert essentially no force on the user. In some embodiments, below the “bottom-free zone” may be the “bottom-exclusion zone”, into which the connector is not allowed to move.

In some embodiments, there may exist similarly specified zones at the opposite end of the reference trajectory. In some embodiments, the “terminal zone” may be perpendicular to the trajectory at the top of the trajectory (i.e., above the top of the trajectory) and its size may be specified by a height parameter. In some embodiments, the default behavior of forces in the terminal zone may be to stay as it is at the top of the trajectory. Alternatively, the user may specify that this region be used for automatically making gradual adjustments to force parameters as the connector moves through it, which may be beneficial when forces are specified to change upon transitioning from the forward stroke to the return stroke.

In some embodiments, this may be valuable in the extreme case of the user specifying a “force-flip”. In some embodiments, with force-flip enabled, the resistance force may flip direction each time the stroke state transitions from forward to return or from return to forward. In some embodiments, a gradual change in force inside the terminal zone may avoid an uncomfortable jolt to the user which otherwise would be experiencing an abrupt change in the force at the top of the trajectory. In some embodiments, in the safety zone, there may be a gradual change in force at the bottom of the trajectory. In some embodiments, to take advantage of the gradual change in resistance force in both the safety zone and terminal zone, the points on the trajectory that define the end of the forward stroke and end of the return stroke may be adjusted via user specification.

In some embodiments, the “top-free zone” may exist above the terminal zone and its size is specified by a height parameter. In some embodiments, the “top-free zone” may be perpendicular to the trajectory at the top. In this region the connector may exert essentially no force on the user. In some embodiments, beyond the top-free zone may be a “top-exclusion zone”, into which the connector is not allowed to move.

In some embodiments, along the length of the reference trajectory may be a “radial-free zone”. In some embodiments, the size of the “radial-free zone” may be specified by a radial distance parameter. In some embodiments, the connector may exert no radially directed force on the user in the “radial-free zone”.

In some embodiments, a “radial zone” may exist radially beyond (i.e., on the outside of) the radial-free zone and its size may be specified by a radial distance parameter. In some embodiments, in the “radial zone”, the connector may exert a radial force on the user, attempting to revert the connector back toward the reference trajectory. In some embodiments, the radial force may simulate a simple mechanical spring. The force magnitude may depend on a spring constant and radial distance of the connector inside the radial zone.

In some embodiments, a “max-radial zone” may exist radially beyond the radial zone on the outside of the radial zone, and its size may be specified by a radial distance parameter. In some embodiments, in the “max-radial zone”, the connector may exert a radial force on the user of constant magnitude, attempting to revert the connector toward the reference trajectory. In some embodiments, the magnitude of radial force in the max-radial zone may be equal to the magnitude of radial force at the outer perimeter of the radial zone.

In some embodiments, radially beyond the max-radial zone there may be a “radial-exclusion zone”, into which the connector is not allowed to move.

In some embodiments, a user may specify the values for each height and radial distance parameter, thus specifying the size and location for each of the zones. Setting the value of any of these parameters to zero may effectively remove the associated zone. In some embodiments, zero may be the default value for all zones, which results in a reference trajectory surrounded by only exclusion zones. In some embodiments, whether any other type of zones should be included and how big they should be may depend on the user, their goals, and the nature of the exercise.

In some embodiments, reference trajectories may be linked together to form a new reference trajectory. Each constituent reference trajectory may be referred to as a “segment” of the new trajectory. This may expand the set of allowable reference trajectories, which is otherwise limited by a minimum angle constraint applied to reference trajectories. More specifically, no three consecutive positional points of a reference trajectory may form an angle in three-dimensional space that is smaller than a system-specified value. However, in some embodiments, that angle constraint may not apply at the point where two segments are joined together. For the purposes of a good user experience, in some embodiments, the processor may consider only one segment of a trajectory to be “active” at any given time. In some embodiments, inactive segments do not contribute to force or related calculations. In some embodiments, for trajectories with only one segment, that segment may persistently maintain its active state.

### Specification of Elemental Forces

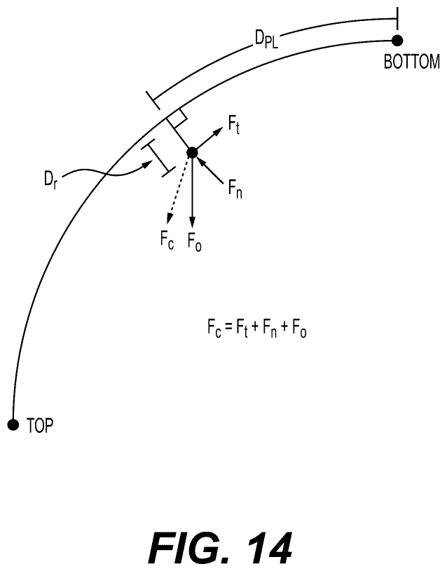

FIG. 14 shows an exemplary connector position along an example reference trajectory and the different elemental forces that can act at this point. One quantity used in this exemplary calculation of forces is the path length (referred to herein as “Dₚₗ”) along the reference trajectory in relation to the connector position. In some embodiments, Dₚₗ is measured starting from the bottom of the trajectory, along the trajectory, and up to the location on the active trajectory segment that is closest in Euclidean distance to the position of the connector.

Another quantity used in this exemplary calculation is the deviation of the connector location from the reference trajectory. In some embodiments, this deviation (referred to herein as “Dᵣ”) is the length of the line segment (referred to herein as the “deviation line segment”) defined by the position of the connector at one end and at the other end by the location on the active reference trajectory segment that is closest in Euclidean distance to the position of the connector. In some embodiments, if necessary, the active trajectory segment may be lengthened by extrapolation such that the intersection between it and the deviation line segment is orthogonal. Because the deviation line segment is always orthogonal to the reference trajectory (be it extrapolated or not), its length is referred to as a “radial distance”.

In some embodiments, at the exemplary connector location shown in FIG. 14, like at other positions, the connector may exert different forces on the user. In some embodiments, these forces may combine into a total force (referred to herein as “F_{c}”) on the user. In some embodiments, each robotic arm (16, 17) through its connector may exert F_{c} in essentially any three-dimensional direction that is specified. In some embodiments, as part of creating an Exercise, the user may specify one or more elemental forces that combine to form F_{c}.

There are many possible schemes for the specification of the different kinds of elemental forces. FIG. 14 illustrates one exemplary embodiment, in which there are three different kinds of elemental forces. A tangential force (referred to herein as “Fₜ”) is parallel to the reference trajectory relative to the location on the reference trajectory that is closest in Euclidean distance to the connector position. A radial force (referred to herein as “Fᵣ”) is perpendicular to Fₜ and pointing along the deviation line segment. An additional elemental force is required for some exercises. This force is referred to herein as the “other force” or “Fₒ”. Multiple instances of Fₒ, each with different behavior, can be specified for an exercise.

In some embodiments, there may be flexibility in the specification of the direction of Fₒ. In some embodiments, Fₒ may be a force perpendicular to Fₜ, but not necessarily parallel to Fᵣ. Alternatively, in some embodiments, Fₒ may be parallel to Fₜ. For example, Fₒ may be specified as a kind of “reference trajectory spring force” between two connectors in the sense that it may act to revert the connectors back to the same respective location on each of their own reference trajectories. More specifically, consider two connectors, each with a reference trajectory and the two trajectories are equal in length. Consider the first connector with a current Dₚₗ value of “x₀”, and the second connector with a current Dₚₗ value of “x₀+dx”. A reference trajectory spring force on the first connector may act to push it forward to a location on its reference trajectory which has a Dₚₗ value of “x₀+dx/2”. The force on the second connector may act to push it backward to a location on its reference trajectory that has a Dₚₗ value of “x₀+dx/2”.

In some embodiments, Fₒ may be specified as an attractive-repulsive force between two connectors. In this case, Fₒ may be parallel to the line formed by the locations of the two connectors. In some embodiments, Fₒ may be specified to point in the direction of an axis of the base coordinate frame or the body coordinate frame of a connector.

Additionally, in some embodiments, the user may also specify the parameters defining the magnitude of Fₒ. For example, in the case of an attractive-repulsive force between two connectors, the magnitude may be specified by user-specified parameters akin to a spring constant and natural spring length.

In some embodiments, there may be exercises for which the force of resistance would be constantly directed along the path of motion. Therefore, in some embodiments, Fₜ may be the source of resistance in such exercises. Example exercises may include the bicep curl and straight leg raise.

In some embodiments, there may be exercises for which the force of resistance would not be consistently directed along the path of motion. For example, certain dumbbell exercises may have their path of motion not entirely vertical, yet the resistance force would be directed downward, as it naturally is because of gravity. Therefore, in some embodiments, specifying Fₒ to point downward along the primary axis may be the source of resistance in such exercises. Example exercises may include the lunge and single-leg Romanian dead lift.

In some embodiments, for each Exercise, the user may specify the behavior regarding force magnitudes for Fₜ, Fᵣ, and Fₒ by choosing a function for each force which defines its magnitude based on input variables and user-specified parameters. In some embodiments, the resistance force may simulate a weight force based on a user-specified mass. This may be done by implementing Newton's law of F=ma in the high-level supervisory control software. Despite the overwhelming popularity of mass-based systems for exercise, their inertial nature has the fundamental flaw of allowing users to “throw” the weight, making it temporarily easier after the weight has been thrown.

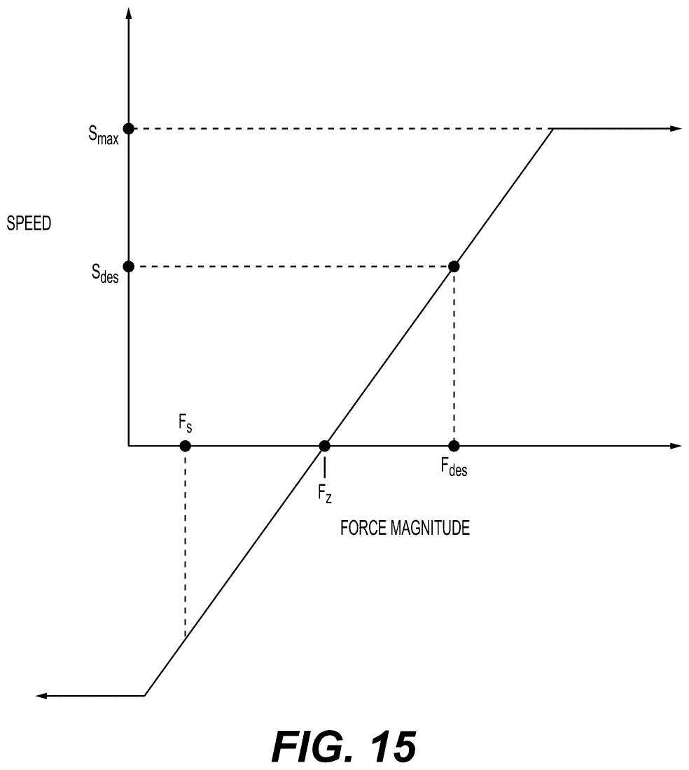

In some embodiments, the resistance force may be based on simulation of a viscous damping force, with a few variations. In some embodiments, a simple viscous damping force may be modeled as a linear dependency between force and current speed. This may involve a single parameter of viscous damping coefficient. An exemplary force-speed functional dependency shown graphically in FIG. 15 involves four user-specified parameters. First is a zero-speed-force (referred to herein as “F_{z}”). In geometric terms, F_{z} is where the force-speed line intersects the Force axis. In practical terms, F_{z} is the magnitude of resistance force when the connector has zero speed. The slope of the force-speed line may be defined by the quotient of two other user-specified parameters, a desired speed (referred to herein as “S_{des}”) divided by a desired force (referred to herein as “F_{des}”). The fourth user-specified parameter is maximum speed (referred to herein as “Sₘₐₓ”). In practical terms, Sₘₐₓ establishes the maximum speed of the connector, regardless of the amount of force applied. In some embodiments, the user may specify these four parameters, which are collectively referred to herein as the “resistance force magnitude parameters”. In some embodiments, the input variable may be the force applied by the user on the connector, and the resulting output may be the speed at which the connector moves. Note that per Newton's third law of motion, the connector may apply an equal-and-opposite force back on the user.

In some embodiments, the slope of the force-speed line may change while a rep is being performed via a force scaling multiplier that may be specified for each point in the reference trajectory. In some embodiments, at any given time, the specific multiplier value that is used from the time series of points may be based on the current value of Dₚₗ. In some embodiments, there may be an additional safety-related parameter, which is referred to herein as “Fₛ”. In some embodiments, if the user specifies a value for Fₛ, and exerts on the connector a force with a magnitude less than Fₛ, the connector may come to a stop irrespective of the specified force-speed dependency. Note that the same kind of damping function can be analogously used for torques and angular velocities.

In some embodiments, the resistance force magnitude parameters may automatically adjust in value based on user specification. For example, in some embodiments, in strength training for the resistance may change as the user progresses through the sets of an exercise. In some embodiments, resistance force magnitude parameters may adjust based on set number.

In some embodiments, another dependency may be on the rep number or stroke state, which in the latter case means a change in resistance force between the forward stroke and return stroke. In some embodiments, this dependency may base on a complex function. For example, in some embodiments, resistance force may change based on how the user is performing. If the user is falling behind in completing the sets in their routine within the specified time, resistance force may be reduced. If the strength of a user is improving from one routine to the next, the resistance force may adapt accordingly (i.e., increase).

In some embodiments, the radial force, Fᵣ, is generally not effective as a source of resistance during an exercise. It is useful in reverting a connector back towards a reference trajectory and/or providing a “signal” to the user when they divert from the trajectory. As with Fₜ and Fₒ, in some embodiments, one of a plurality of functions may be used for defining the magnitude of Fᵣ. In some embodiments, the calculation for Fᵣ may simulate a simple mechanical spring.

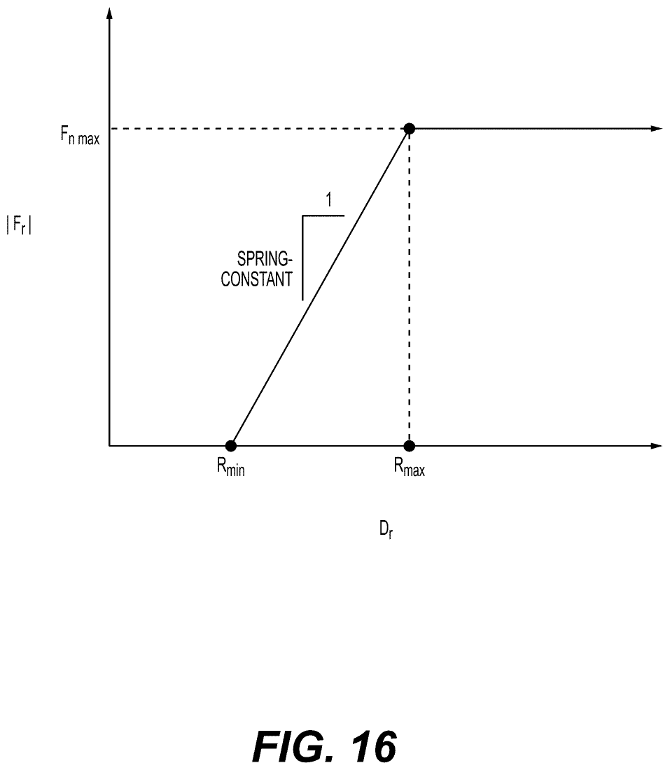

FIG. 16 shows the magnitude of Fᵣ as a linear function of radial distance inside of the radial zone. In some embodiments, the slope of the line in the radial zone may be a user-specified spring constant. In some embodiments, the input variable may be the current radial distance, Dᵣ. In some embodiments, for radial distances smaller than Rₘᵢₙ, the magnitude of Fᵣ may be zero. Here, Rₘᵢₙ defines the radial thickness of the radial-free zone and the beginning of the radial zone. The difference of Rₘₐₓ and Rₘᵢₙ may define the thickness of the radial zone. For radial distances larger than Rₘₐₓ, in some embodiments, the magnitude of Fᵣ may stay constant at a value of Fₙₘₐₓ. In some embodiments, the input variable may be a predicted value of Dᵣ. The prediction may be based on Dᵣ, the velocity of the connector, the reference trajectory, a prediction time-step value, and possibly other quantities.

### Supervisory Control of Robotic Arms

In some embodiments, the exercise machine (10) may comprise one or more computers. In some embodiments, the computers may be separate from the exercise machine, and connected to the exercise machine via a cable. In the exemplary embodiment of FIGS. 1 and 2, the exercise machine (10) contains two computers (24, 25) inside of the user console (14). These computers (24, 25) may execute software programs for low-level control of the robotic arms (16, 17), high-level supervisory control of the robotic arms (16, 17), and operating GUIs presented on the displays of the exercise machine (10). In some embodiments, the computers (24, 25) may execute software for sensor data processing. This may include, for example, HPE processing of raw vision sensor (21, 22, 23) data. In some embodiments, the computers (24, 25) may execute software for interaction with remote cloud resources (26) and local mobile devices (27).

In some embodiments, the first computer (24) may execute the software programs for low-level and high-level control of the robotic arms (16, 17), including processing of robotic arm (16, 17) sensor data. Therefore, in some embodiments, the first computer (24) may exclusively dedicate itself to the critical task of relatively high-frequency, direct robotic arm (16, 17) control. In some embodiments, the second computer (25) may execute all other required software programs. While software programs that are executed on the second computer (25) may ultimately impact the movement of the robotic arms (16, 17), it occurs at low frequency and indirectly via communication between the first computer (24) and second computer (25). For example, the Exercise Mode GUI (34) may transmit inputs to the high-level supervisory control software during user rest periods between sets. In some embodiments, different allocations of software execution and/or alternate numbers of computers may be possible.

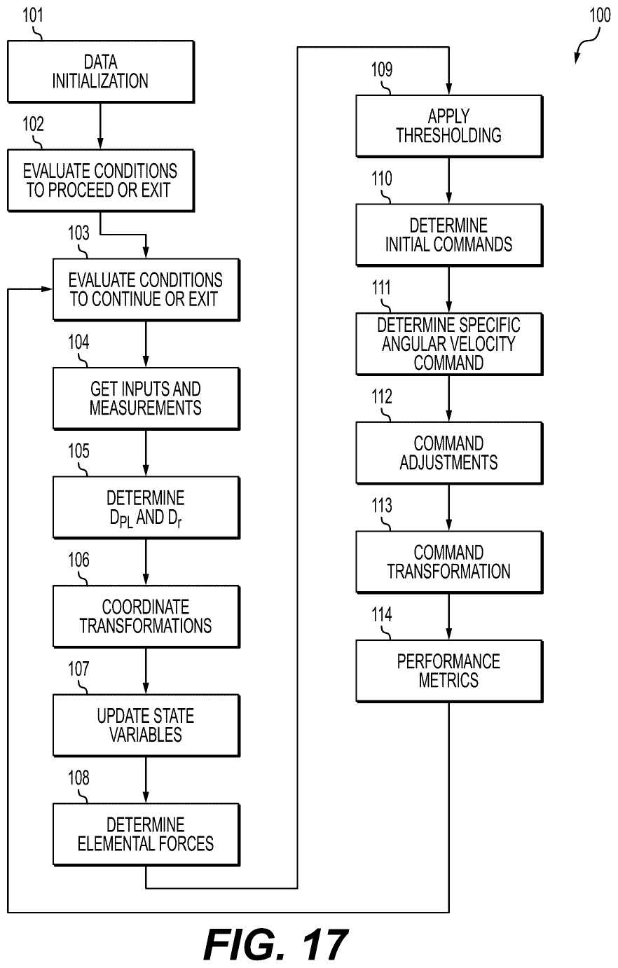

In some embodiments, FIG. 17 is a flowchart illustrating an exemplary embodiment of a process for supervisory control of a robotic arm (16, 17). In some embodiments, the process (100) may be implemented in software. In some embodiments, the process (100) may control the robotic arms (16, 17) for the various modes of the exercise machine (10) by determining supervisory commands which may be transmitted to the low-level controller. In some modes, however, some steps of process (100) may be irrelevant. For example, in Teaching Mode, step 105 may be skipped because there is no pre-existing reference trajectory.

In some embodiments, in step 101, the processor may initialize data, such as initial values for resistance force magnitude parameters and various state variables, including the stroke state of the rep, among others. In some embodiments, the processor may assign the default initial value for the stroke state to a value indicating forward stroke. In some embodiments, data for initialization may be automatically transmitted from the software program for the GUI associated with the current mode of the exercise machine (10). In some embodiments, the processor may use this data to initialize parameters and other variables to enable the user to start and complete a set during Exercise Mode, to create a new Motion during Teaching Mode, or to perform a training activity. In some embodiments, training activities may include, for example, guiding a user through a given motion or conducting a stretch or other recuperative activity.

In some embodiments, in step 102, the processor may continuously evaluate conditions of the exercise machine (10) to determine if the main loop should begin or if the process (100) should prematurely stop. In some embodiments, the trigger to proceed with the main loop in Exercise Mode may be time-based and determined from the user-specified rest time between sets. In some embodiments, there may be other triggers involving sensor measurements such as pulse rate of the user or the user being in proper initial position and pose based on HPE processing. In some embodiments, the user may specify a combination of conditions. In some embodiments, the trigger in Training Mode may be one of many conditions, such as the user simultaneously nudging the involved connectors. In some embodiments, the main loop may begin with step 103 when the specified trigger conditions are satisfied.

In some embodiments, in step 103, the processor may check criteria for terminating the loop or continuing. In some embodiments, criteria to terminate may include, for example, meeting the specified number of reps or checking for early termination via user input on the Exercise Mode GUI (34). In some embodiments, other termination criteria may be possible. For example, stretching exercises may use a time-based criterion.

In some embodiments, in step 104, the processor may obtain measurements from the robotic arm (16, 17) sensors as well as inputs from other executing processes. In some embodiments, the measurements may include connector position, orientation, velocity, and angular velocity, as well as the force and torque being exerted on the connector. In some embodiments, the inputs may include information transmitted from software programs for GUIs and vision sensor processing, and other executing instances of the process (100).

In some embodiments, in step 105, the processor may determine the current Dₚₗ and Dᵣ values. In some embodiments, in step 106, the processor may determine different coordinate frame transformations, such as the transformation from the base coordinate frame to the connector body coordinate frame. In some embodiments, in step 106, the processor may apply the said transformations to the measured quantities obtained in step 104 and to other quantities. In some embodiments, the choice of coordinate frame for calculations throughout the process (100) may be a matter of convenience or a matter of necessity. For example, during the final transformation of supervisory commands, the calculations must necessarily be in the coordinate frame expected by the low-level controller.

In some embodiments, in step 107, the processor may update various state variables based on the sensor measurements. In some embodiments, the state variables may include the rep number and the stroke state. In some embodiments, if the stroke state indicates “forward stroke”, the stroke state value may not transition to “return stroke” until all involved connectors reach the top of the motion. In some embodiments, if the stroke state indicates “return stroke”, the stroke state value may not transition to “forward stroke” until all involved connectors reach the bottom of the motion. In some embodiments, the processor may increase the rep number variable by increments of one each time the stroke state transitions from “return stroke” to “forward stroke”. In some embodiments, for multi-segment trajectories, the processor may update a variable that indicates an “active” segment. An active segment is defined as the segment that is closest in Euclidean distance to the connector, subject to two constraints. In some embodiments, a first constraint may limit the active segment variable to transition only to a value that indicates a segment which is adjacent to the currently active segment. In some embodiments, a second constraint may limit the transition to be only in the direction as indicated by the stroke state. In some embodiments, the default initial value for the active segment variable may indicate the first segment of the multi-segment trajectory. In some embodiments, this initialization may be done in step 101.

In some embodiments, in step 108, the processor may determine all the elemental forces that the connector is to exert on the user based at least in part on sensor measurements. In some embodiments, these elemental forces may include Fₜ, Fᵣ, and one or more instances of Fₒ. In some embodiments, in step 109, the processor may combine the elemental forces with the force measured from the force-torque sensor, and apply thresholding. In some embodiments, in applying thresholding, the processor may adjust force magnitudes based on net forces being below a system-specified minimum value. In some embodiments, thresholding may benefit the user experience and suppress issues arising from force-torque sensor noise. In some embodiments, thresholding, in effect, may simulate a friction force. In some embodiments, thresholding may simulate both static and dynamic friction by switching the minimum value between two different system-specified values based on speed of the connector. In some embodiments, the processor may apply thresholding to the measured torques.

In some embodiments, in step 110, the processor may determine the initial connector velocity and angular velocity commands based at least in part on force and torque values resulting in step 109 and user-specified parameters, such as resistance force magnitude parameters, among others. In some embodiments, the processor may determine a separate version of a three-dimensional angular velocity command based on Dₚₗ. In some embodiments, the processor may use Dₚₗ to index into the time series of three-dimensional orientation data in the reference trajectory. In some embodiments, the processor may use the three-dimensional orientation associated with the current value for Dₚₗ, and the current measurement of actual connector orientation to determine the three-dimensional angular velocity command. The control algorithms that can implement this calculation are well known to those skilled in the art of control system engineering. In some embodiments, such algorithms can also use connector velocity to predict a future value of Dₚₗ, which is used for indexing instead of the current value of Dₚₗ.

In some embodiments, in step 111, the processor may determine how to use the two different versions of angular velocity commands. In some embodiments, it may be based on the current mode of the exercise machine. For example, in both Exercise Mode and Training Mode, a connector may track the orientation specified in the reference trajectory. In Teaching Mode, the connector may respond to user-exerted torque. In some embodiments, hybrid behavior may be an option in Exercise Mode. For example, the processor may determine two orientation angles based on the reference trajectory and the third orientation angle may be based on user-exerted torque. In some embodiments, the result of step 111 may be a single version of an angular velocity command.

In some embodiments, in step 112, the connector velocity and angular velocity commands may undergo certain adjustments. In some embodiments, reasons for such adjustments may include, for example, enforcing any user-specified or system-specified exclusion zones around the reference trajectory. In some embodiments, the processor may automatically create system-specified exclusion zones to prevent each robotic arm (16, 17) from colliding with each other or another member of the exercise machine (10). In some embodiments, these exclusion zones may also prevent the robotic arm (16, 17) from getting too close to a singularity condition.

In some embodiments, the processor may implement a spotter feature via velocity command adjustment. In some embodiments, the processor may implement user-specified zero-motion constraints via adjustment of velocity and/or angular velocity commands. In some embodiments, each of these adjustments may involve setting a component of the connector velocity command or angular velocity command to zero after performing the appropriate coordinate transformation, and then transforming the adjusted velocity or angular velocity command back to the previous coordinate frame. In some embodiments, the processor may use vibration of the connector to signal to the user certain events, such as reaching the top of the motion. In some embodiments, the processor may simulate vibration by overlaying a small-magnitude oscillation on the connector angular velocity command along one or more axes.

In some embodiments, because of lag in the response of the low-level controller, the connector may inadvertently land across the boundary of an exclusion zone. In this case, the processor may temporarily add a velocity component to eject the connector from the exclusion zone. In some embodiments, the processor may apply more sophisticated control algorithms that are well-known to those skilled in the art of control system engineering. In some embodiments, such control algorithms may mitigate the issue of a connector crossing the boundary of an exclusion zone.

In some embodiments, in step 113, the processor may transform the adjusted connector velocity and angular velocity commands to the coordinate frame that is expected by the low-level controller. In some embodiments, the processor may transmit the commands after their transformation to the low-level controller.

In some embodiments, in step 114, the processor may determine various performance metrics. In some embodiments, these metrics may include, for example, time-to-go in the routine and calories burned, among other quantities. In some embodiments, the loop may return to step 103 after step 114 is completed.

In some embodiments, there may be a trade-off in the rate at which the loop in process 100 executes. If the loop executes too slowly, the user experience may be comprised. In some embodiments, higher rates may require more powerful and expensive processors. In some embodiments, there is also diminishing benefit to the user experience at excessively high rates. For example, a rate of 200 Hz has been shown to be reasonable, but slower or faster rates may be acceptable. In some embodiments, the processor may execute an independent instance of the process (100) for each robotic arm (16, 17) as required for a given Motion.

### Human Pose Estimation and Other User Sensing

In some embodiments, the processor may process raw vision sensor (21, 22, 23) measurements for HPE. Various open- and closed-source software packages are available for HPE. These packages may support concurrent data from two or more vision sensors. In one embodiment, the exercise machine comprises one vision sensor. With only one vision sensor, however, there may be certain user positions and poses for which parts of the user's body are not visible to the vision sensor. In some embodiments, additional vision sensors may mitigate the issue of occlusion and provide better HPE performance. The exemplary embodiment illustrated in FIGS. 1 and 2 comprises three vision sensors (21, 22, 23), each is in a different position and therefore, each has a unique line-of-sight to the user.

In some embodiments, HPE may enable multiple features across the different modes of the exercise machine (10). In some embodiments, in Teaching Mode, the computer (24, 25) may record information while the user demonstrates a new motion. In some embodiments, the recorded information may include vision sensor (21, 22, 23) measurements, measurements of connector position and orientation, and other data. In some embodiments, after the demonstration process is complete, the processor may upload the data from the exercise machine (10) to the cloud (26). In some embodiments, the three-dimensional HPE may be performed in the cloud (26), using the uploaded data to determine the time series of the user's joint angles as they were during the motion demonstration. In some embodiments, this process may be executed in the cloud (26) “offline”, and not performed in real-time as part of an actively occurring routine or demonstration. In some embodiments, both forward- and backward-smoothing may be applied to the time series of user joint angles.

In some embodiments, it is assumed that demonstrations are performed with proper form. Therefore, the time series of user joint angles that are computed from three-dimensional HPE in the cloud (26) are considered to be proper. In some embodiments, the time series of proper joint angles from the demonstrated motion may enable automatic adaptation of a Motion to any user. This adaptation may apply to users with body sizes that are substantially different from the user that performed the demonstration. In some embodiments, this may be achieved by applying forward kinematics and the time series of proper joint angles to the KBM of any user to produce a reference trajectory tailored to that user. In some embodiments, the time series of proper joint angles may be used as the standard in determining proper form when any user is performing the associated motion during a scheduled routine.

In some embodiments, the processor may perform two-dimensional HPE in real-time during Exercise Mode. In some embodiments, the processor may apply the real-time user joint angles to the current user's KBM and graphically present them on one or more displays of the exercise machine (10). In some embodiments, the processor may simultaneously graphically overlay another instance of the current user's KBM with the proper joint angles applied. In some embodiments, this graphical overlay may be based on a two-dimensional perspective projection of a three-dimensional KBM using the same line-of-sight as the vision sensor providing measurements for real-time two-dimensional HPE. In some embodiments, at any given moment, the specific proper joint angles that are applied from the entire time series of proper joint angles may be based on the current value of either duration or Dₚₗ. In some embodiments, a user may make this choice sometime prior to performing the set. Specifically, in some embodiments, current duration may be measured as the passage of time relative to when the user begins performing the set. If based on Dₚₗ, and two connectors with symmetric reference trajectories are involved in the exercise, the processor may use the average value of Dₚₗ for both connectors to determine the specific proper joint angles that are applied. In some embodiments, the time series of proper joint angles may be indexed by both Dₚₗ and duration. In some embodiments, “three-dimensional KBM” refers to a KBM with joint angles applied that result in the KBM existing not within a plane, but in a three-dimensional space.

In some embodiments, the processors of the exercise machine (10) can automatically choose the vision sensor (21, 22, 23) providing the best line-of-sight, giving the user the best perspective. Alternatively, in some embodiments, the user may select one or more vision sensors (21, 22, 23) providing the perspective(s) of their choice. In some embodiments, any divergence that the user observes between the two graphical KBMs is corrective real-time feedback to the user. This graphical information may help the user get into the proper initial position and pose to begin the set.

In some embodiments, the same processes in Exercise Mode can also occur in Training Mode, during which the exercise machine (10) may assist the user to learn a new motion. In some embodiments, when Training Mode is used for recuperative activities, the processor may use HPE information, for example, to guide the movement of a foam roller across the user's muscles. In some embodiments, HPE may be used as an extra safety precaution. For example, when the connectors are automatically moving to their starting position and orientation for a new set, the processor may pause this movement based on risk of bumping the user.

In some embodiments, different types of sensors can be part of or connect to the exercise machine (10). In some embodiments, the processor may present the processed sensor data in real-time on one or more of the displays of the exercise machine (10) and/or save the processed data with other routine performance data for subsequent data analysis.

In some embodiments, the processor may use real-time sensor data as part of a trigger. For example, a user may want a trigger specified in terms of their heart rate, which would allow the user to proceed with a set. A user with a heart ailment may specify a maximum heart rate value. In this exemplary case, the exercise machine (10) may prevent the next set from being performed until the user's heart rate falls below the specified maximum value. Alternatively, in some embodiments, a healthy user seeking to improve their cardiorespiratory fitness may specify a minimum heart rate value. In this case, the processor may prompt the user to begin their next set when their heart rate falls below a specified minimum value.

In some embodiments, a user may wear a wireless monitoring device, and the device can wirelessly connect to the exercise machine (10). There are many quantities of the user's condition that can be relevant. For example, a body-worn device may include sensing capabilities for body temperature, heart rate, respiratory rate, and blood oxygenation level. In some embodiments, some sensors may measure quantities for a processor to estimate user pain level. In some embodiments, some sensors may measure quantities without physical contact. For example, a vision sensor may monitor heart rate through changes in skin color as blood pressure fluctuates with the heartbeat cycle.

### Creating a New Exercise Motion

In some embodiments, user demonstration may be an efficient method for specifying the reference trajectory of a new Motion. In some embodiments, to start, a user may log in to the exercise machine (10) and initiate Teaching Mode. In some embodiments, in Teaching Mode, the connectors may be free to move under the influence of user-exerted forces and torques with relatively little resistance.

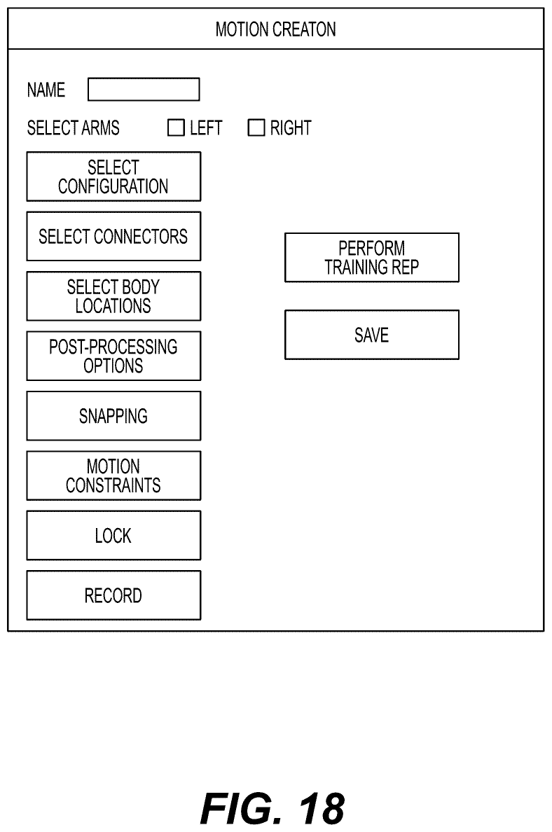

FIG. 18 shows an exemplary Teaching Mode GUI. In some embodiments, the user may interact with this GUI via a display of the exercise machine (10).

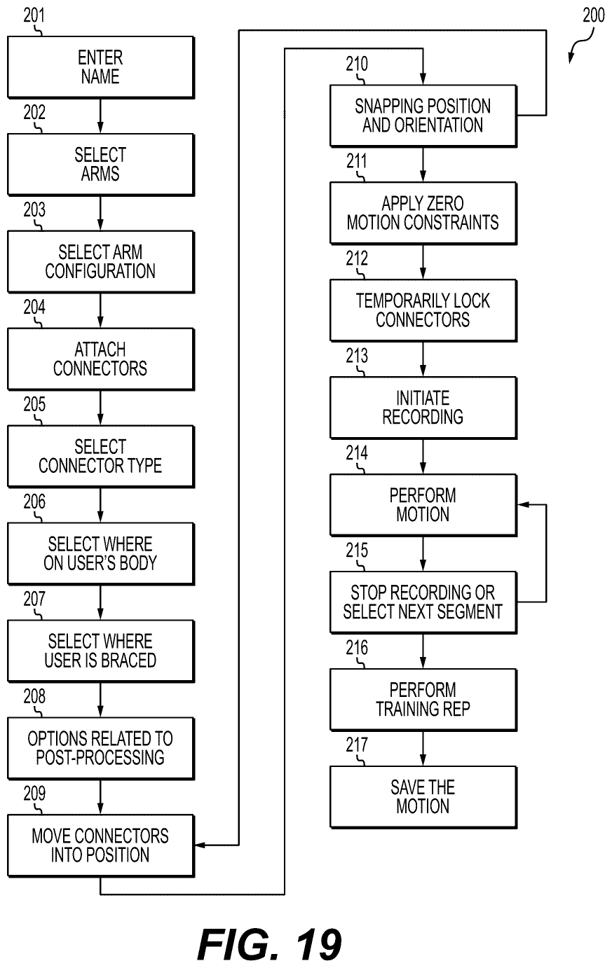

FIG. 19 is a flowchart that illustrates the method (200) of creating a new Motion. In some embodiments, in step 201, the user may enter a name for the Motion, or allow the processor to apply an automatically generated default name.

In some embodiments, in step 202, the user may select which robotic arms (16, 17) are to be involved in the demonstration, or by default both are included.

In some embodiments, in step 203, the user may select a configuration for each robotic arm (16, 17), or allow the processor to apply the default configuration.

In some embodiments, transitioning a robotic arm (16, 17) from one configuration to another may require moving through a singularity (i.e., a transition point). In some embodiments, the user may wait for each robot arm (16, 17) to move itself from one configuration to another, instead of that transition happening under the influence of user-exerted forces and torques. In some embodiments, each robotic arm (16, 17) may therefore maintain its selected configuration throughout an exercise motion. In some embodiments, the exercise machine (10) may have six active joints per robotic arm (16, 17), there may be two configuration parameters to be chosen for each robotic arm (16, 17), one for the elbow and one for the wrist.

In some embodiments, in step 204, the user may attach the desired connector to each arm, as required.

In some embodiments, in step 205, the user may select the connector type attached to each robotic arm (16, 17) from a list of predefined options, or allow the processor to apply a default type. In some embodiments, the user may select which passive joints, if any, on the selected connector type are unlocked, otherwise allow the processor to assume by default that tall joints are locked.

In some embodiments, in step 206, the user may select where on their body each connector would be interfacing, or allow the processor to apply a default location for each connector to be interfacing. For example, the user may make or imply this selection by gripping one connector with their right hand and another connector with their left hand.

In some embodiments, in step 207, the user may optionally select which of their body parts are to be statically interfaced to the platform (11) or a supporting structure on the platform (11).

In some embodiments, in step 208, the user may select options related to post-processing of the reference trajectory data and other saved measurements.

In some embodiments, there may be an option relating to symmetry when two robotic arms (16, 17) are involved in the motion. In some embodiments, if the symmetric option is enabled, the processor may automatically adjust position and orientation data so that the two reference trajectories are symmetric with each other about the centerline (15) in translational and angular positions. In some embodiments, the processor may also impose symmetry on the time series of proper user joint angles.

In some embodiments, there may be an option indicating what connector orientation angles should remain unchanged, and which connector orientation angles should be changed, based on KBM forward kinematics.

In some embodiments, in step 209, the user may move each connector as necessary into its initial position and orientation for the start of the motion.

In some embodiments, the order of steps 202 through 209 may be rearranged. In some embodiments, some of these steps may occur at any point prior to step 217. For example, steps 201 and 208 may occur at any point in time prior to step 217;

In some embodiments, steps 211, 212, and 213 may occur in any order.

In some embodiments, in step 210, the user may have the option of snapping the position and/or orientation of the connectors to certain user-specified values. In some embodiments, the processors may automatically perform this adjustment in position and/or orientation by the robotic arms (16, 17). An example of snapping to position is an adjustment of the positions of the connectors such that they are symmetric about the centerline (15). To be symmetric in position about the centerline (15) means that the two connectors are equidistant from, but on opposite sides of, the centerline (15) while the primary and longitudinal positional values are equal (respectively). In some embodiments, the processor may impose such symmetry through “averaging” the positions of the two connectors. First, the processor may apply a reflection matrix to the position vector of one of the two connectors so that the new position represents a flip to the opposite side of the centerline (15). Second, the processor may independently average position values for each axis across both connectors. Finally, the processor may apply the reflection matrix again using the averaged position in association with the same connector as before. Each connector may then assume its newly determined position.

In an exemplary embodiment, snapping to an orientation can be an automatic adjustment of the orientation of two gripping connector handles (39) such that they are parallel to the plane of the platform (11) and their rotation about the primary axis is symmetric with each other. To be symmetric in orientation about the primary axis means, for example, that the rotation angles about the primary axis for both connectors are equal in magnitude but opposite in sign.

In some embodiments, snapping the orientations of two connectors such that they are symmetric about the centerline may also be possible for arbitrary orientations. Such a calculation may require a few steps. First, the processor may apply a reflection matrix to one of body coordinate frames, in effect shifting it to the opposite side of the centerline (15). Second, the processor may determine swing-twist parameters for both body frames, and then average the swing and twist parameters. Third, the processor may convert the averaged swing-twist parameters back to a three-axis body frame representation. Finally, the processor may apply the same reflection matrix to determine the averaged orientation on the opposite side of the centerline (15). Each connector may then assume its newly determined orientation.

In some embodiments, if the user is unhappy with the result of any snapping process, the user may go back to step 209, manually move the connectors, and then snap again.

In some embodiments, in step 211, the user may optionally specify one or more zero-motion constraints for each connector. In some embodiments, the user may specify a zero-motion constraint by selecting a coordinate frame and an axis associated with the coordinate frame. For each constraint, the user may also specify whether the constraint is translational or rotational. For example, the user may select the lateral axis in the base coordinate frame for a translational constraint. In this case, the connectors cannot move laterally from their initial position throughout the entire motion. As another example, the user may select an axis of the connector body coordinate frame for a rotational constraint. This may result in the connector not being able to rotate about the specified axis.

In some embodiments, in step 212, the user may have the option of temporarily locking all movement of the connectors so the user can get into position and grab, or otherwise connect to, the connectors without disturbing them.

In some embodiments, in step 213, a user or a partner to the user may initiate motion recording. In some embodiments, if a user is already in position to start the motion, a partner to the user may initiate recording via the GUI. In some embodiments, the user or a partner to the user may trigger recording through some other means such as a time delay from the initiation of the lock in step 212. In some embodiments, the user may first initiate recording via the GUI and then get into position and grab, or otherwise connect to, the connectors. In some embodiments, the initiation of recording may automatically terminate the lock from step 212, allowing the connectors to move.

In some embodiments, in step 214, the user may perform the forward stroke of the motion. In some embodiments, while the user performs the forward stroke, the processors may continuously record measurements of position and orientation of each connector in addition to raw vision sensor measurement data. In some embodiments, the processor may record other information, such as time.

In some embodiments, if, during the motion, any connector comes too close to a system-specified exclusion zone, the Teaching Mode GUI may present a warning with relevant information. In some embodiments, if a connector moves closer and bumps into an exclusion zone, the motion may be adversely affected. This may yield an invalid demonstration with a message presented by the Teaching Mode GUI containing advice on how to avoid the exclusion zone. In some embodiments, the advice may be adjusting the starting position of the connectors, using a different kind of connector, using a different configuration for the robotic arms (16, 17), and/or unlocking one of the passive joints of the connectors. In some embodiments, when passive joints are unlocked, the robotic arms (16, 17) can attempt to exploit the additional degree-of-freedom by skirting around a wrist singularity.

In some embodiments, the user may proceed to the next step after successfully demonstrating the forward stroke of the motion.

In some embodiments, in step 215, the user, via the GUI, may either stop recording or select the option to demonstrate the next segment as part of a multi-segment trajectory. In the latter case, the user may return to step 214 to demonstrate the next segment, repeating this sequence until all segments are recorded. After recording is stopped, a computer (24, 25) may automatically perform initial data processing so that the reference trajectory information can be saved in a format usable by the supervisory control process (100) of FIG. 17. In some embodiments, this may be required if the user wants to try out the motion with a training rep before saving the new Motion.

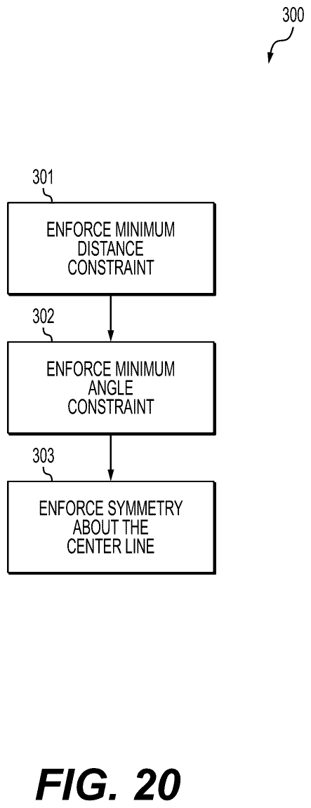

An exemplary automated process (300) that transforms raw connector position and orientation measurements into a usable format is shown in FIG. 20. In some embodiments, in step 301, the processor may enforce a minimum Euclidean distance constraint so that no two consecutive points of the reference trajectory are closer than a system-defined critical distance. In some embodiments, the critical distance value may be one centimeter. In some embodiments, the critical distance value may be a constant value, smaller or larger than one centimeter.

In some embodiments, in step 302, the processor may enforce a minimum angle constraint so that no three consecutive points of the reference trajectory form an angle less than a system-defined critical angle. In some embodiments, the minimum angle constraint may prevent any turning of the reference trajectory from being too drastic. In some embodiments, the critical angle value may be about 175 degrees. In some embodiments, the critical angle value may be a constant value smaller or larger than 175 degrees. Regarding the angular measurement approach, three consecutive points that exist consecutively on a straight line are considered to form an angle of 180 degrees. Three consecutive points that consecutively form a right angle are considered to form an angle of 90 degrees.

In some embodiments, excessively large or small critical values may adversely affect the user experience. Whether the critical value is excessively large or small depends on the details of how an Exercise is specified.

In some embodiments, the processor may not enforce a minimum angle constraint at the junction of two reference trajectory segments. In some embodiments, the active segment variable may play a role in mitigating degradation of the user experience that might otherwise occur near the junction. In some embodiments, these system-defined critical values may have a functional dependency, such as dependence on the physical size of the user. In some embodiments, the critical values may be explicitly specified by the user. The issue of possible user experience degradation remains a risk, however.

In some embodiments, step 303 may apply only if two connectors are involved in the exercise motion and if the symmetry option associated with step 208 is enabled. In some embodiments, in step 303, the processor may adjust the position and orientation data so that the two reference trajectories are completely symmetric with each other about the centerline (15) in translational and angular position at every point in the reference trajectory. In some embodiments, this may result in the two reference trajectories appearing as “mirror images” of each other across the centerline (15).

In some embodiments, after process (300) is completed, the user may have the option of performing a training rep in step 216. In some embodiments, in a training rep, the exercise machine (10) may guide the user through a new motion to verify its correctness. In some embodiments, if the user is not satisfied with the reference trajectory after completing the training rep, the user may return to an earlier step in method (200). Finally, in step 217 the user may save the Motion and upload it to the cloud (26). A Motion, with the name specified by the user, may become accessible to the user through a GUI, such as the Exercise Plan Creator GUI (29) shown in FIG. 3.

### Processing New Motion Data

In some embodiments, the newly uploaded Motion may contain raw measurements of position and orientation for each connector and raw vision sensor (21, 22, 23) measurements. In some embodiments, the raw measurements of both position and orientation are time series data as they span the entire demonstrated motion. In some embodiments, the Motion may contain other data, such as user-specified settings that were chosen during method (200).

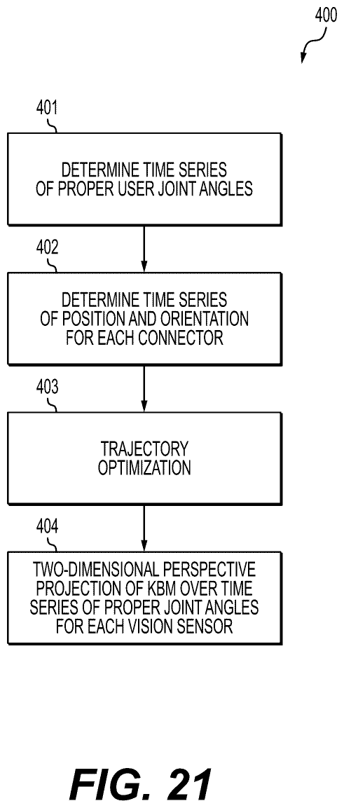

In some embodiments, additional data processing may be necessary before the Motion can be downloaded to an exercise machine (10) as part of a scheduled routine. FIG. 21 shows an exemplary embodiment of this data processing process (400), which may be automatically executed in the cloud (26) and “behind the scenes” from the perspective of any user. Alternatively, in some embodiments, process (400) may be executed by one of the computers (24, 25) of the exercise machine (10) with the results subsequently uploaded to the cloud (26).

In some embodiments, in step 401, three-dimensional HPE may determine the time series of proper user joint angles as they were throughout the demonstrated motion. In some embodiments, in step 401, the processor may use data recorded during step 214, such as vision sensor (21, 22, 23) data, position and orientation measurements for each connector, and other data. In some embodiments, in step 401, the processor may incorporate other data, such as the KBM of the user that performed the motion demonstration, and user-specified settings that were chosen during method 200, such as the symmetry option associated with step 208.

In some embodiments, if the symmetry option is enabled, the processor may adjust the time series of proper user joint angles so that each side of the user's body and the two reference trajectories that result from step 402 are symmetric with each other (respectively) about the centerline (15). In some embodiments, there may be various ways to enforce this symmetric constraint. For example, the processor may assume the joint angles on one side of the user's body as correct and determine the joint angles on the other side based on those. For another example, the processor may assume that the “average” of the two time series of proper angles is correct. Any such approach may involve swing-twist parameterization of the of the locations on the user's body that are interfacing with the connectors, parameterization for redundant degrees-of-freedom in the user's body, and inverse kinematics applied to the KBM.

In some embodiments, in step 402, the processor may use forward kinematics to determine the time series of three-dimensional position values in base coordinates for each connector. In some embodiments, the processor may in step 402 apply the time series of proper joint angles that were computed in step 401 to the KBM of the user for whom the trajectory is being adapted. In some embodiments, the processor may use other data, such as user-specified settings that were chosen during method 200. In some embodiments, in step 402, the processor may determine the time series of three-dimensional connector orientation values such that each connector is appropriately oriented throughout the motion, based on forward kinematics of a user's KBM and incorporates user input associated with the orientation option of step 208. In some embodiments, the orientation of the KBM at the location where each connector interfaces with the user may dictate the orientation of the connector insofar as the orientation option may allow it to be changed relative to the originally measured orientation values.

In some embodiments, in step 402, the processor may index the time series of proper joint angles calculated in step 401 by both duration and Dₚₗ. In some embodiments, the processor may index the tailored reference trajectory by both duration and Dₚₗ. Duration is measured as the passage of time relative to when the connectors begin to move along their respective trajectories. Indexing by Dₚₗ could not occur in step 401 because the tailored reference trajectory data did not exist as of step 401. In some embodiments, the processor may save the time series of proper joint angles and the tailored reference trajectory data as part of the Motion.

In some embodiments, in step 403, the processor may optimize the location of the tailored reference trajectory in the base coordinate frame for various factors, such as singularity zone avoidance and robot arm performance. In some embodiments, the processors in step 403 may use the tailored reference trajectory that is determined in step 402, among other data. For example, when connector speed and force parameters are specified for an Exercise, the location of the reference trajectory for that Exercise can undergo further optimization. In some embodiments, this location optimization may consider robotic arm force and manipulability ellipsoids.

In some embodiments, all optimizations are constrained such that the essentials of the user experience of performing the motion are unaffected by the optimization process. In some embodiments, all forward kinematics and optimization processes may adhere to any applicable user- and system-specified constraints.

In some embodiments, the processor may save the updated reference trajectory for each connector as part of the Motion.

In some embodiments, the processor in step 403 may determine the starting location of each connector along its reference trajectory. In some embodiments, certain user settings and user-specified force parameters may result in the starting location being something other than the bottom of the reference trajectory. For example, reversed-phase may be a setting that may result in the starting location being not at the bottom of the reference trajectory.

In some embodiments, in step 404, the processor may project the KBM of a user onto a two-dimensional space to simulate the effect of two-dimensional HPE performed on a user whose joint angles transition through the time series of proper joint angles. In some embodiments, the processor in step 404 may apply the time series of proper joint angles from step 401, and a line-of-sight for the two-dimensional perspective projection that is based on the location and orientation of a vision sensor (21, 22, 23). In some embodiments, the processor may repeat step 404 for each vision sensor (21, 22, 23) of the exercise machine (10). The result may be a time series of projected KBMs for each vision sensor (21, 22, 23). In some embodiments, the processor may index these time series by both duration and Dₚₗ and save these time series as part of the Motion. These indexed time series represent proper body pose throughout the motion from the perspective of each vision sensor (21, 22, 23). In some embodiments, during Exercise Mode, the processor may graphically overlay these time series may on one or more displays of the exercise machine (10) with actual body pose. In some embodiments, the processor may determine the actual body pose from real-time two-dimensional HPE.

In some embodiments, the processor may execute step 401 after creating a new Motion via demonstration.

In some embodiments, steps 402 through 404 may be user-specific (i.e., each user may have their own user-specific data for steps 402 through 404). In some embodiments, in addition to being user-specific, step 403 may be Exercise-specific (i.e., each Exercise may have its own Exercise-specific data for step 403), as optimizations of the reference trajectory of a Motion depend on data associated with the Exercise that contains said Motion.

In some embodiments, the processor may execute step 402 for a given user at any time after step 401 is executed, but before step 403 is executed for the same user. In some embodiments, the processor may execute steps 403 and 404 for a given user prior to that user's scheduled routine time, and for each relevant Motion contained in said Routine. In some embodiments, for any given user, the processor may repeat step 402 if the body of said user sufficiently changes relative to their body at the time step 402 was previously executed.

In some embodiments, KBM length values might be so large that it is mathematically impossible to adapt a particular Motion to a user. When a user is assigned to a Routine and adaptation is impossible for one or more Motions in that Routine, a web and/or mobile app may provide appropriate notification. In some embodiments, the user may need to use a different Motion. The processor may appropriately annotate or filter Motions from view in the Exercise Plan Creator GUI (29).

### Kinematic Body Model

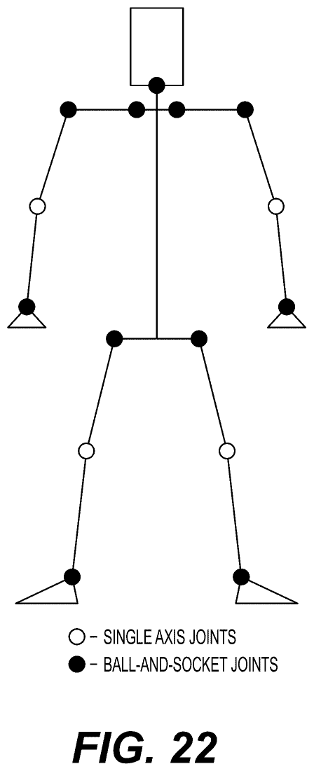

In some embodiments, the exercise machine (10) may scan the body of a user to develop an initial KBM. The KBM is an abstract representation of the user that contains information about the user's joints and body part lengths. A template may define the structure of the KBM. In some embodiments, the processor may adopt one of various templates in developing the initial KBM. FIG. 22 illustrates one exemplary template. In this exemplary embodiment, the template uses single-axis joints for the elbows and knees, and ball-and-socket joints for the ankles, wrists, hip sockets, shoulder sockets, shoulders, neck, and lower-back. In some embodiments, the template may include other joints, for example, to capture movement of the mid-back. In some embodiments, some joints are connected by rigid segments that have only length. In some embodiments, the segments may include lower legs, upper legs, collarbones, upper-arms, and lower-arms. In some embodiments, the feet, hands, hip, torso and head may have length and width. In some embodiments, a user may make modifications, including adjustments to accommodate for amputated limbs.

In some embodiments, during Body Scanning Mode, a user may follow instructions on a display of the exercise machine (10) to perform a series of different body movements and poses. The instructions may be in textual and/or graphical form. In some embodiments, performing the body movements and poses following instructions may involve the user interfacing with connectors. In some embodiments, the body scanning may incorporate precise measurements of connector position and orientation into the calculations.

While the user is following the instructions, in some embodiments, the processor may use a template to automatically refine a KBM for the user. In some embodiments, the processor may estimate the lengths of all the segments based on HPE processing. In some embodiments, the processor may execute the HPE processing to estimate segment lengths after the exercise machine (10) uploads data to the cloud (26). The processor may then compare the prediction and the actual measurements and update lengths of all the segments in the model until the estimates and measurements satisfactorily converge.

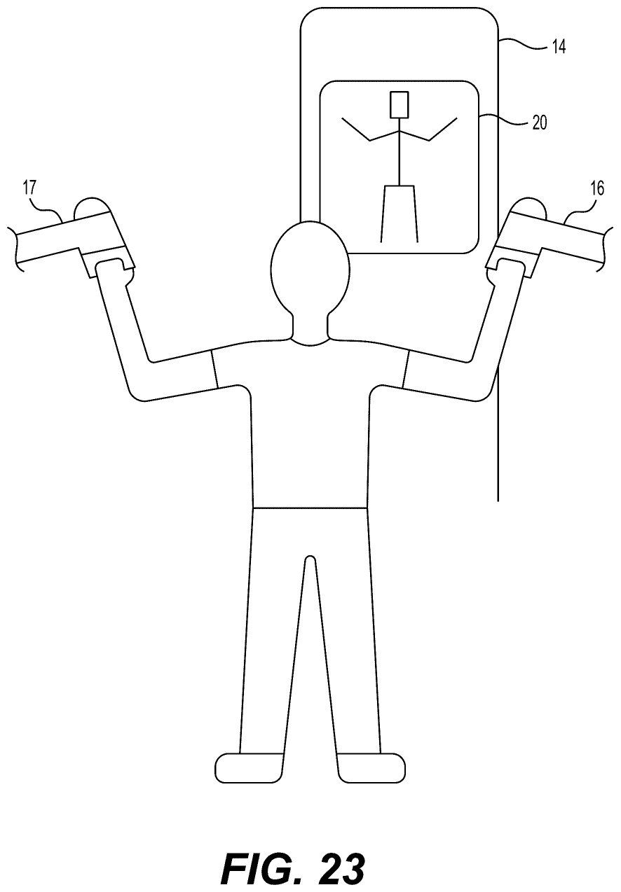

FIG. 23 shows a user and an exemplary GUI presented on the display (20). In this exemplary embodiment, the GUI presents a graphical representation of the desired pose overlayed with real-time HPE data. In some embodiments, when the user completes a pose by closely matching the desired pose, the exercise machine (10) may prompt the user to move on to the next pose.

In some embodiments, the KBM of a user may enable a plurality of features. For example, a KBM may be used in HPE processing. In some embodiments, the processor may adapt a Motion to users of different body sizes by applying forward kinematics on their respective KBMs to produce a user-tailored reference trajectory. Additionally, in some embodiments, the processor may use KBMs to present a graphical representation of the user on any display of the exercise machine (10). In some embodiments, the processor may continually update the KBM of a user with each completion of a scheduled routine to keep the KBMs relevant when the bodies of the users are changing over time.

In some embodiments, the processor may use the same process for creating an initial KBM to produce a volumetric body model. In some embodiments, as the volumetric body model is updated through the course of an exercise plan, the processor may perform data analytics to incorporate historical volumetric body model data with other recorded data. In some embodiments, the processor may use a volumetric body model for presenting a graphical representation of the user's body. In some embodiments, the processor may use a volumetric body model in making refinements to a reference trajectory during the process of adapting a Motion to a user.

### Strength-Endurance-Mobility Profile

In some embodiments, a SEM profile may contain quantitative information about a user's strength, endurance, and mobility. In some embodiments, after a user's KBM has been created, the user may perform a routine that is specifically designed for developing an initial estimate of the user's SEM profile. While the user performs the routine, the processor may record information about the performance of the user. In some embodiments, the processor may upload, from the exercise machine (10) to the cloud (26), this recorded information, which may include vision sensor (21, 22, 23) data, time, connector measurements, and other data. In some embodiments, the processor may then process the uploaded data to form an initial estimate of the user's strength, endurance, and mobility across a plurality of motions. In some embodiments, the processor may continually update the user's SEM profile with each completion of a scheduled routine, to maintain historical SEM profile data in the cloud (26).

In some embodiments, SEM profiles may enable a plurality of features. In some embodiments, the processor may automatically adapt a Routine that is new to a user to that user. For example, the processor may adapt desired force and speed parameters of each Exercise in the Routine to a user. In some embodiments, the processor may use mobility information in a SEM profile to further refine each reference trajectory. In some embodiments, mobility information may establish the joint limits for the KBM of a user, which affects the location of the top and bottom of a tailored reference trajectory.

In some embodiments, a SEM profile may be instrumental in adapting Routines that have been part of the user's Plan. In some embodiments, as the strength, endurance, and/or mobility of a user improve over time, their Plan and constituent Routines can adapt according to the user's changing SEM profile. Additionally, in some embodiments, historical SEM profile data may provide a rigorous and consistent way of depicting the progress of a user over time. In some embodiments, the processor may graphically present historical SEM data to a user via a web app delivered by the cloud (26).

### Example Exercises

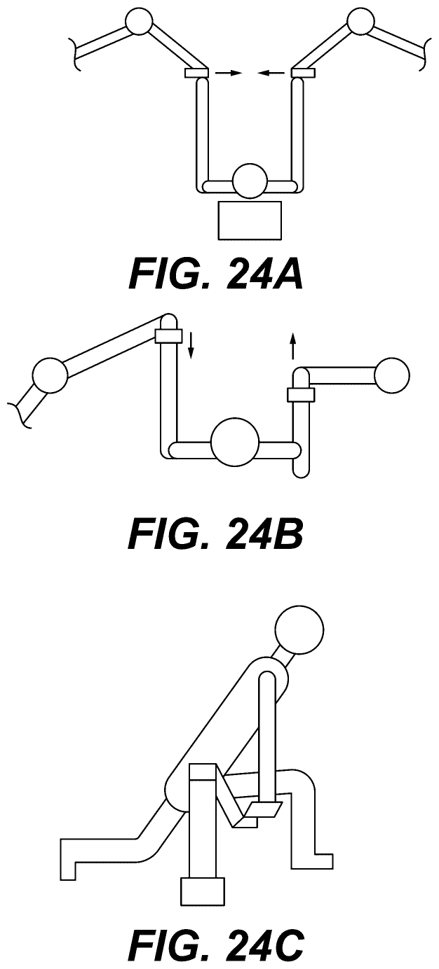

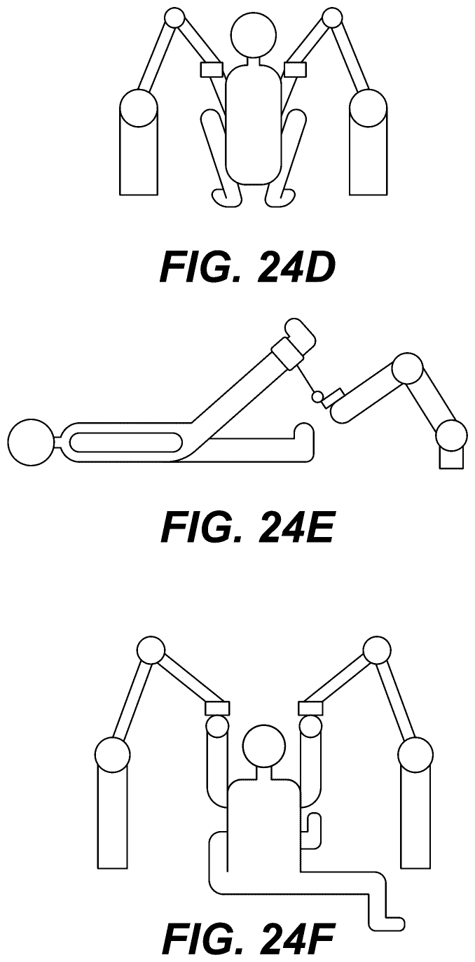

FIGS. 24A-24F show exemplary exercises that can be performed with the exercise machine (10). These examples highlight distinctive aspects of embodiments of the present disclosure that may enable unique exercises.

FIG. 24A illustrates a traditional bench press exercise. In this exemplary embodiment, at the top of the upward motion. there is an additional squeeze motion that involves the user bringing their hands closer together. This squeeze motion may isolate the chest muscles. In this exemplary embodiment, the user may specify the squeeze portion of this exercise using an additional reference trajectory segment. With a two-segment trajectory approach, Fₒ can be specified to be pointing in the opposite direction of the primary axis when the second segment is active. This two-segment trajectory approach may maintain force uniformity along the primary axis as the user performs the squeeze motion, moving the connectors along the lateral axis. In some embodiment, the bench press exercise may involve higher resistance force on the return stroke, which may be specified by using different force parameters for the return stroke as compared to the forward stroke.

FIG. 24B illustrates an exercise that involves multiple upper body muscle groups, as well as core muscles. In this exemplary embodiment, the exercise involves an alternating push-pull motion while the user is standing straight up. With one of the user's arms pushing while the other is pulling, the user's oblique core muscles may be recruited. In this exemplary embodiment, the specification of this exercise may include selections for reversed-phase and force-flip. Together, these selections may result in the simultaneous push-pull nature of the exercise. In this exemplary embodiment, the exercise can be made isometric by specifying a non-zero F_{z} value, which may result in push and pull forces exerted on the user even when the user pauses movement along the trajectory.

FIG. 24C illustrates a traditional lunge exercise. In addition to improving lower body strength, this exercise may help with developing balance and stability. This exercise may achieve this because of the difficulty the user has in maintaining balance throughout the motion. Furthermore, this exercise has an increasing strength curve, meaning that more muscular effort is required the deeper the user goes into the lunging motion.

For users who find the lunge challenging, some embodiments have features that can get a novice user started safely, and help them develop their lunge strength, balance, and stability. In some embodiments, specifying for both connectors a zero-motion translational constraint along the lateral axis and a zero-motion rotational constraint for all three axes may provide significant assistive stability. In some embodiments, however, these arrangements may not provide sufficient stability for the user because the connectors may still be able to move independently along their respective reference trajectories. For additional support, in some embodiments, the user may specify the exercise to include bilateral motion. With this option enabled, the two connectors may move in unison along their respective reference trajectories. In some embodiments, the bilateral motion option may constrain the movement of the two connectors insofar as they each automatically maintain the same Dₚₗ value along their respective reference trajectories.

In some embodiments, the Exercise Mode GUI (34) may depict the amount of stability assistance provided and how user performance is improving. In some embodiments, as the user's balance and stability improve, the user may disable the bilateral motion option and specify a reference trajectory spring force. This arrangement may mitigate, but not exclude, the risk of the user tipping over during the motion. In some embodiments, forcing the user to maintain balance and stability to some degree on their own may lead to further improvement of the user's balance and stability.

In this exemplary embodiment, Fₜ, being parallel to the reference trajectory, is largely irrelevant to this exercise. This may be especially true in the upper portion of the motion when the user's forward knee has a relatively small joint angle. In this portion of the motion, the reference trajectory may have a significant longitudinal component. However, resistance force in the longitudinal direction may not be desirable in a lunge exercise. In this exemplary embodiment, this may be addressed by setting Fₜ to zero and specifying Fₒ to always act along the primary axis. In this exemplary embodiment, Fₒ acts as the resistance force of the exercise. In some embodiments, such an Fₒ specification may be accompanied with the specification of a radial-free zone, providing a space through which Fₒ can operate. In some embodiments, multiple Fₒ forces may be specified for the same exercise, as a separate Fₒ force may act as reference trajectory spring force.

In some embodiments, for a user who wants to do a deep lunge but is concerned about the increasing strength curve, the user may specify the resistance force to decrease as the user gets deeper into their lunge. In some embodiments, the user may specify the resistance force to decrease below a value of zero, in effect producing an assistive force in the lower portion of the motion. In some embodiments, this assistance may counteract some of the user's own body weight, which can be a significant component of resistance given the nature of a lunge exercise. In some embodiments, as the user's performance increases from one routine to the next, the point of transition between resistive and assistive force may get lower in the motion, eventually becoming unnecessary. In some embodiments, the assistive force may be an option during warm-up. In some embodiments, the lunge may be used for pre-routine dynamic stretching, and assistance would mitigate risk of injury to cold muscles.

In some embodiments, the default starting point for a motion is generally the bottom of a reference trajectory. However, in some embodiments, the existence of an assistive force in the bottom portion of the reference trajectory may result in the bottom not being a stable point. For example, a connector may begin to move before the user has a chance to interface with the connector. In this case, the default behavior is for the starting point of each connector to be located at the transition point from an assistive to resistive force. The transition point is a stable point because assistive and resistive forces are zero in magnitude. In some embodiments, the processor may calculate the location of the stable point along the reference trajectory in step 403. Alternatively, in some embodiments, a user may have the option of specifying the starting point of each connector to be anywhere along the reference trajectory. As part of this option, the user may also specify a trigger so that no connector moves under the influence of any elemental force until the trigger condition is satisfied. In some embodiments, the trigger may be, for example, the user simultaneously nudging all connectors involved in the exercise.

FIG. 24D illustrates a unique full-body exercise that has a mix of compound motions and isolated motions, and no return stroke. In this exemplary embodiment, the user starts with a squat forward stroke, then a standing shoulder press forward stroke, and then a standing lateral push-down forward stroke. From there, the user may assume another squat position by sitting back and adjusting their hand positions appropriately, which is the position in which the user started. In this exemplary embodiment, the specification of this exercise may include a multi-segment reference trajectory for each connector. In some embodiments, the exercise specification may include a circular trajectory option, which allows the user to return to the bottom of the reference trajectory without performing a return stroke.

FIG. 24E illustrates a single leg raise exercise. In this exemplary embodiment, an attaching connector (42) may interface to the user's ankle. This exercise is traditionally performed with an elastic band or a cable machine, neither of which exert a resistance force that is ideally directed. In this exemplary embodiment, the robotic arm (16, 17) automatically may maintain the strap of the attaching connector (42) to be tangent to the velocity of the user's ankle. In some embodiments, the processor may apply forward kinematics to the user's KBM during process 400 to exert ideally directed resistance forces. In some embodiments, this process (400) may account for the length of the attaching connector (42), which is specified via the connector selection in step 205. In some embodiments, the resulting reference trajectory may include a time series of gripping connector (38) positions and orientations that maintain the tangency condition as the user applies tension on the attaching connector (42).

Like the lunge, this exercise motion has a strength curve that can significantly vary throughout the range of motion. The traditional elastic band or cable machine cannot achieve the required variation in resistance force. With the exercise machine (10), however, in some embodiments, the user may specify Fₜ to vary appropriately throughout the motion.

FIG. 24F illustrates a 90-90 hip stretch. This is a stretch for which proper form is important, yet difficult to maintain. It is also a stretch that benefits from a considerable amount of time in the stretched position. For these reasons, in this exemplary embodiment, the user may benefit from stretching assisted by the exercise machine (10). In some embodiments, the gripping connectors (38) may guide the user in the stretch motion and help the user transition to the different stretch poses. In some embodiments, real-time feedback from HPE may enable the user to make necessary adjustments in their pose. In some embodiments, the exercise machine (10) may keep track of the duration of the stretch. In some embodiments, the gripping connectors (38) may follow a reference trajectory but stop short of the top if the amount of back-force exerted by the user becomes too large. With an assistive motion, in some embodiments, a user-specified trigger may determine when the stretch motion begins. For example, one such trigger may be that the user grabbing and simultaneously nudging the connectors.

### Other Embodiments

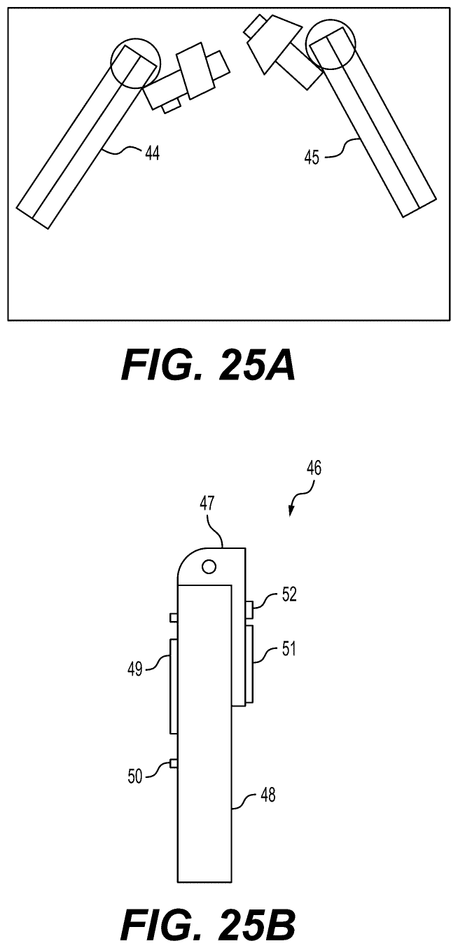

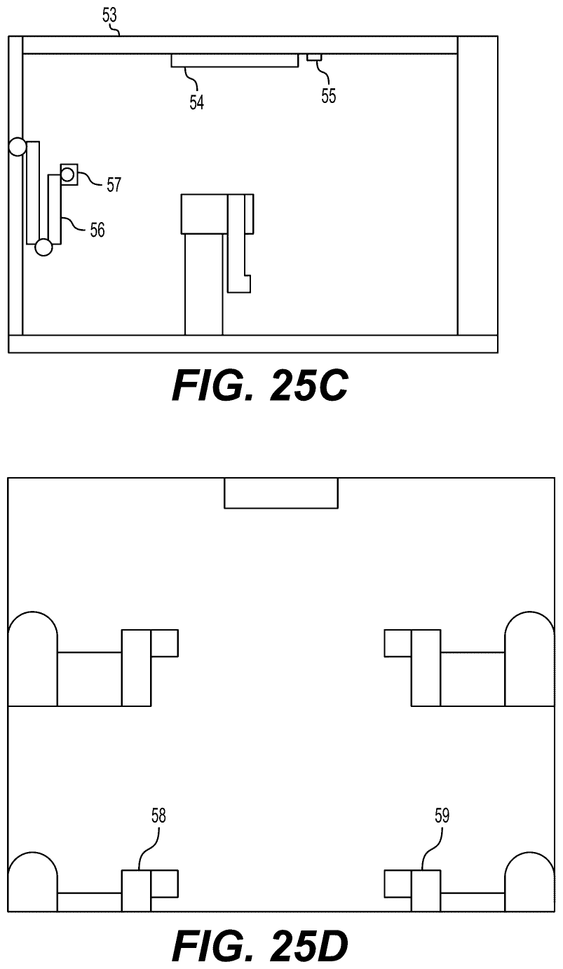

FIGS. 25A-25D illustrate alternative embodiments of the exercise machine. FIG. 25A illustrates two motorized rail systems (44, 45) that are part of the platform that can automatically translate the position of the pedestals to which each is attached. In this exemplary embodiment, the first rail system (44) can reposition the first robotic arm and the second rail system (45) can reposition the second robotic arm. This exemplary embodiment may better accommodate users of different sizes and different types of exercise motions.

FIG. 25B illustrates an alternate embodiment of the user console (46). In this exemplary embodiment, an upper rotating member (47) is hinged to a lower static member (48) of the user console (46). The static member (48) may comprise a display (49) and vision sensor (50). The rotating member (47) may comprise a second display (51) and a second vision sensor (52). In some embodiments, in Idle Mode the rotating member (47) is configured vertically so that the second display (51) is accessible “off platform” from outside of the exercise machine. In some embodiments, the user may use the second display (51) in this configuration for user login. After login, the second display (51) may automatically rotate 270 degrees about the motorized hinge and be accessible “on platform” during Exercise Mode. In this configuration, the second display (51) is viewable when the user is in more of a horizontal position, such as laying on their back for a traditional bench press exercise. In some embodiments, the second vision sensor (52) may have a line-of-sight that is orthogonal to the line-of-sight of the first vision sensor (50). This may be beneficial for HPE processing.

FIG. 25C illustrates an exemplary embodiment of the exercise machine that has some of the same benefits as the user console (46) but avoids the complexity of a motorized rotating member. In this exemplary embodiment, additional framing may provide support for a horizontal member (53). In some embodiments, the horizontal member (53) may comprise a display (54) and vision sensor (55). The exemplary exercise machine of FIG. 25C also comprises a passive, user-controllable arm (56) which is equipped with an end effector (57) to hold a user's mobile device. In this exemplary embodiment, the user may move the end effector (57) so that the display of the mobile device is easily viewable by the user, given their position and pose for an exercise. In some embodiments, a mobile app for the user's mobile device can provide control over what is presented on the display of the mobile device.

FIG. 25D illustrates yet another exemplary embodiment of the exercise machine with four robotic arms. In this exemplary embodiment, a user may use the two additional arms (58, 59) for exercises such as a crunch, which requires interfacing with all four limbs of a user. In some embodiments, the two additional robotic arms (58, 59) may use pads as connectors to act as guides for the user's knees, elbows, or buttocks during an exercise to help with proper form. As the user's body moves through the motion, so can the pads, based on forward kinematics of the user's KBM as determined in process 400. In some embodiments, an additional arm (58, 59) may hold an additional display, such as the user's mobile device. In some embodiments, the additional arm may actively position and orient the mobile device into a position and orientation, as determined in process 400, to maximize user viewability during an exercise. In some embodiments, the additional arm may automatically move the mobile device along with the user. For example, during a squat the mobile device may move up and down with the user's movement.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An exercise machine, comprising:
at least one computer;
at least one sensor; and
at least one robotic arm, each of the at least one robotic arm has a connector through which the robotic arm exerts force and torque on a user;
wherein:
each of the at least one robotic arm moves along a reference trajectory;
the at least one computer controls the at least one robotic arm according to the corresponding reference trajectory; and
the at least one sensor comprises:
at least one force-torque sensor configured to measure the force and torque exerted on the user; and
at least one vision sensor configured to measure the user's body posture.

2. The exercise machine of claim 1, wherein each of the at least one robotic arm comprises at least five joints.

3. The exercise machine of claim 1, wherein the reference trajectory specifies positions and orientations of the corresponding connector.

4. The exercise machine of claim 1, wherein the reference trajectory has a top point and a bottom point, wherein:
the bottom point is above a safety zone;
the top point is below a terminal zone;
the safety zone is above a bottom-free zone;
the terminal zone is below a top-free zone;
the top-free zone is below a top-exclusion zone; and
the bottom-free zone is above a bottom-exclusion zone.

5. The exercise machine of claim 1, wherein:
the reference trajectory locates within a radial-free zone;
a radial zone is radially beyond the radial-free zone; and
when the corresponding connector is located in the radial zone, the corresponding connector exerts a radial force on the user to revert the corresponding connector back toward the radial-free zone.

6. The exercise machine of claim 5, wherein:
a max-radial zone is radially beyond the radial zone on the outside of the radial zone; and
when the corresponding connector is located in the max-radial zone, the corresponding connector exerts a constant radial force on the user to revert the corresponding connector toward the reference trajectory.

7. The exercise machine of claim 1, wherein the at least one sensor comprises three vision sensors to monitor a pose of the user.

8. The exercise machine of claim 7, wherein the pose of the user comprises body positions and joint angles of the user.

9. The exercise machine of claim 1, further comprising at least one display and a graphical user interface (GUI) presented on at least one of the at least one display.

10. The exercise machine of claim 9, wherein the at least one display moves along with the user's body movement.

11. A method for controlling an exercise machine, the exercise machine comprises:
at least one computer;
at least one sensor; and
at least one robotic arm, each of the at least one robotic arm has a connector through which the robotic arm exerts force and torque on a user;
wherein:
each of the at least one robotic arm moves along a reference trajectory;
the at least one computer controls the at least one robotic arm according to the corresponding reference trajectory; and
the at least one sensor comprises:
at least one force-torque sensor configured to measure the force and torque exerted on the user; and
at least one vision sensor configured to measure the user's body posture;
the method comprising:
selecting an exercise motion;
setting initial values for resistance force magnitude parameters and state variables;
determining the user is ready to start exercising;
obtaining measurements from the at least one sensors;
based on the obtained measurements, updating the resistance force magnitude parameters and the state variables.

12. The method for controlling the exercise machine of claim 11, wherein each of the at least one robotic arm comprises at least five joints.

13. The method for controlling the exercise machine of claim 11, wherein the reference trajectory specifies positions and orientations of the corresponding connector.

14. The method for controlling the exercise machine of claim 11, wherein the reference trajectory locates within a radial-free zone, and a radial zone is radially beyond the radial-free zone, the method further comprising:
when the corresponding connector is within the radial zone, exerting a radial force on the user through the corresponding connector to revert the corresponding connector back toward the radial-free zone.

15. The method for controlling the exercise machine of claim 14, wherein a max-radial zone is radially beyond the radial zone on the outside of the radial zone, the method further comprising:
when the corresponding connector is within the max-radial zone, exerting a constant radial force on the user through the corresponding connector to revert the corresponding connector toward the reference trajectory.

16. The method for controlling the exercise machine of claim 11, wherein the at least one sensor comprises three vision sensors to monitor a pose of the user.

17. The method for controlling the exercise machine of claim 16, wherein the pose of the user comprises body positions and joint angles of the user.

18. The method for controlling the exercise machine of claim 12, the exercise machine further comprising at least one display and a graphical user interface (GUI) presented on at least one of the at least one display.

19. The method for controlling the exercise machine of claim 18, further comprising:
displaying, on the at least one display, a time series of proper joint angles; and
based on the measurement from the at least one visual sensors, overlaying a user's body positions and joint angles to the time series of proper joint angles in real-time.

20. The method for controlling the exercise machine of claim 18, further comprising moving the at least one display along with the user's body movement.
